(19) United States
(12) Patent Application Publication
(10) Pub. No.: US 2017/0256283 A1
(43) Pub. Date: Sep. 7, 2017

(54) INFORMATION PROCESSING DEVICE AND INFORMATION PROCESSING METHOD

(71) Applicant: SONY CORPORATION, Tokyo (JP)

(72) Inventors: Masakazu YAJIMA, Chiba (JP); Yoichiro SAKO, Tokyo (JP); Takayuki HIRABAYASHI, Tokyo (JP); Masashi TAKEDA, Tokyo (JP); Hiromitsu KOMATSU, Kanagawa (JP); Kouichirou ONO, Tokyo (JP)

(21) Appl. No.: 15/507,512

(22) PCT Filed: Jun. 16, 2015
(86) PCT No.: PCT/JP2015/067355

§ 371 Date: Feb. 28, 2017

(30) Foreign Application Priority Data
Sep. 8, 2014 (JP) 2014-182771

(51) Int. Cl. G11B 20/10; H04N 21/2665; G11B 27/19; G06T 19/00; H04N 5/77; H04N 9/87

(52) U.S. Cl. CPC G11B 20/10527; H04N 5/77; H04N 9/8715; G11B 27/19; G06T 19/006; H04N 21/2665; G11B 2020/10537

(57) ABSTRACT

Excellent information processing device, information processing method, and information processing system capable of viewing a content without temporal and spatial limitation are provided. When an arithmetic device 120 receives position/attitude information and time information from an information device 141 on a reproduction side, this loads information of an image and audio around the position information of the device and around the time from a database 111 and reconfigures an image and audio to be reproduced from wanted viewing time from a viewpoint viewing from which is wanted. The reconfigured image and audio are reproduced while being loaded into a main storage unit 202 in the information devices 141 on the reproduction side through a network 150.

### TECHNICAL FIELD

The technology disclosed in this specification relates to an information processing device and an information processing method for sharing information such as a moving image and audio among users, and especially relates to the information processing device and the information processing method for reproducing the information such as the image and audio without temporal or spatial limitation.

### BACKGROUND ART

An information device having a function of reproducing information such as a video content and an audio content is already widely popularized. For example, there are a cell phone such as a smartphone, a tablet terminal, a digital book, a portable music player and the like. There also is an information device mounted on a part of a user's body such as a head and an arm to be used such as a head mount display and a wristband type device.

The information devices are capable of viewing various contents such as contents downloaded in advance, contents recorded (shot/audio recorded) on site, those reproduced through a network (including real-time streaming), and contents obtained by assigning augmented reality in real time by using augmented reality (AR) technology.

There also is the information device provided with a function of reproducing the content which has a chase reproduction function to reproduce a moving image file now being recorded from an arbitrary reproduction position (for example, refer to Patent Document 1) or a high-speed reproduction function to rapidly find a desired screen (for example, refer to Patent Document 2). A user may easily view the content from an arbitrary time point by using the functions.

### CITATION LIST

### Patent Document

Patent Document 1: Japanese Patent Application Laid-Open No. 2011-229064
Patent Document 2: Japanese Patent Application Laid-Open No. 2013-5054
Patent Document 3: Japanese Patent No. 4695583
Patent Document 4: Japanese Patent Application Laid-Open No. 2012-44390

### SUMMARY OF THE INVENTION

### Problems to be Solved by the Invention

An object of the technology disclosed in this specification is to provide excellent information processing device and information processing method capable of viewing contents without temporal or spatial limitation.

### Solutions to Problems

The technology disclosed in this specification is realized in view of the above-described problems, and a first aspect thereof is

an information processing device including:

an information obtaining unit which obtains information of an image or audio;

a sensor information obtaining unit which obtains position/attitude information or other sensor information when the information of the image or audio is obtained; and

a storage unit which stores the obtained information of the image or audio in a database together with the sensor information.

According to a second aspect of the technology disclosed in this specification, the storage unit of the information processing device according to the first aspect is configured to store the information of the image or audio in a dedicated database on a network or a database of a moving image sharing site.

According to a third aspect of the technology disclosed in this specification, the storage unit of the information processing device according to the first aspect is configured to correct blurring when recording the image and audio.

Also, a fourth aspect of the technology disclosed in this specification is

an information processing device including:

an information obtaining unit which obtains information of an image or audio stored in a database; and

an arithmetic processing unit which reproduces information at an arbitrary time point or in an arbitrary place from information which is image recorded or audio recorded at different time or in a different place.

According to a fifth aspect of the technology disclosed in this specification, the database stores the information of the image or audio together with position/attitude information or other sensor information. Then, the arithmetic processing unit of the information processing device according to the fourth aspect is configured to reproduce the information of the image or audio with the position/attitude information of a viewpoint viewing from which is wanted and time.

According to a sixth aspect of the technology disclosed in this specification, the arithmetic processing unit of the information processing device according to the fifth aspect is configured to perform a reproduction process of the image or audio according to temporal difference between wanted viewing time and present time.

According to a seventh aspect of the technology disclosed in this specification, the arithmetic processing unit of the information processing device according to the sixth aspect is configured to generate a real-time image when the temporal difference between the wanted viewing time and the present time is smaller than a predetermined threshold.

According to an eighth aspect of the technology disclosed in this specification, the arithmetic processing unit of the information processing device according to the seventh aspect is configured to generate the real-time image in arbitrary place/viewpoint when spatial difference between a generated image and a real image is not smaller than a predetermined threshold.

According to a ninth aspect of the technology disclosed in this specification, the arithmetic processing unit of the information processing device according to the sixth aspect is configured to generate a future image when the wanted viewing time is in the future with the temporal difference from the present time not smaller than a predetermined threshold.

According to a tenth aspect of the technology disclosed in this specification, the arithmetic processing unit of the information processing device according to the ninth aspect is configured to generate the future image in arbitrary place/viewpoint and at arbitrary time when a spatial difference between a generated image and a real image is not smaller than a predetermined threshold and generate the future image in a fixed place, an arbitrary viewpoint, and at arbitrary time when the spatial difference is smaller than the predetermined threshold.

According to an eleventh aspect of the technology disclosed in this specification, the arithmetic processing unit of the information processing device according to the sixth aspect is configured to generate a playback image when the wanted viewing time is in the past with the temporal difference from the present time not smaller than a predetermined threshold.

According to a twelfth aspect of the technology disclosed in this specification, the arithmetic processing unit of the information processing device according to the eleventh aspect is configured to generate the playback image in arbitrary place/viewpoint and at arbitrary time when spatial difference between a generated image and a real image is not smaller than a predetermined threshold and generate the playback image in a fixed place, an arbitrary viewpoint, and at arbitrary time when the spatial difference is smaller than the predetermined threshold.

Also, a thirteenth aspect of the technology disclosed in this specification is an information processing method including:

an information obtaining step of obtaining information of an image or audio;

a sensor information obtaining step of obtaining position/attitude information or other sensor information when the information of the image or audio is obtained; and

a storing step of storing the obtained information of the image or audio in a database together with the sensor information.

Also, a fourteenth aspect of the technology disclosed in this specification is an information processing method including:

an information obtaining step of obtaining information of an image or audio stored in a database; and

an arithmetic processing step of reproducing information at an arbitrary time point or in an arbitrary place from information which is image recorded or audio recorded at different time or in a different place.

### Effects of the Invention

According to the technology disclosed in this specification, excellent information processing device and information processing method capable reproducing information at an arbitrary time point and in an arbitrary place without temporal or spatial limitation may be provided.

Meanwhile, the effect described in this specification is illustrative only and the effect of the present invention is not limited to this. There also is a case in which the present invention has further additional effect in addition to the above-described effect.

Still another object, feature, and advantage of the technology disclosed in this specification will become clear by further detailed description with reference to an embodiment to be described later and the attached drawings.

### BRIEF DESCRIPTION OF DRAWINGS

FIG. 1 is a view schematically illustrating a configuration of an information reproduction system 100 according to one embodiment of the technology disclosed in this specification.

FIG. 2 is a view illustrating an internal configuration example of an information device 101 which records information presented to a user.

FIG. 3 is a view illustrating an internal configuration example of an information input unit 204 for inputting the information to be recorded.

FIG. 4 is a view illustrating an internal configuration example of an information device 141 which presents the recorded information to the user.

FIG. 5 is a view illustrating an internal configuration example of an information output unit 205 which reproduces and outputs the recorded information to present to the user.

FIG. 6 is a view illustrating an internal configuration example of a stand-alone information device which inputs the information to be recorded, records the information, and reproduces and outputs the recorded information.

FIG. 7 is a flowchart illustrating an example of a basic process executed by information devices 101, 102, . . . , and 10n on a recording side.

FIG. 8 is a flowchart illustrating an example of the basic process executed by the information devices 101, 102, . . . , and 10n on the recording side.

FIG. 9 is a flowchart illustrating an example of the basic process executed by the information devices 101, 102, . . . , and 10n on the recording side.

FIG. 10 is a flowchart illustrating an example of the basic process executed by the information devices 101, 102, . . . , and 10n on the recording side.

FIG. 11 is a flowchart illustrating an example of the basic process executed by information devices 141, 142, . . . , and 14m on a viewing side.

FIG. 12 is a flowchart illustrating an example of the basic process executed by the information devices 141, 142, . . . , and 14m on the viewing side.

FIG. 13 is a flowchart illustrating a procedure of generating a synthetic image.

FIG. 14 is a flowchart illustrating the procedure of generating the synthetic image.

FIG. 15 is a flowchart illustrating the procedure of generating the synthetic image.

FIG. 16 is a flowchart illustrating a detailed procedure of a synthesizing process of a virtual space image.

FIG. 17 is a flowchart illustrating the detailed procedure of the synthesizing process of the virtual space image.

FIG. 18 is a flowchart illustrating a detailed procedure of a synthesizing process of an estimated future image in arbitrary place/viewpoint and at arbitrary time.

FIG. 19 is a flowchart illustrating the detailed procedure of the synthesizing process of the estimated future image in arbitrary place/viewpoint and at arbitrary time.

FIG. 20 is a flowchart illustrating a detailed procedure of a synthesizing process of an estimated future image in fixed place/viewpoint and at arbitrary time.

FIG. 21 is a flowchart illustrating the detailed procedure of the synthesizing process of the estimated future image in the fixed place/viewpoint at arbitrary time.

FIG. 22 is a flowchart illustrating a detailed procedure of a synthesizing process of a playback image in arbitrary place/viewpoint and at arbitrary time.

FIG. 23 is a flowchart illustrating the detailed procedure of the synthesizing process of the playback image in arbitrary place/viewpoint and at arbitrary time.

FIG. 24 is a flowchart illustrating a detailed procedure of a synthesizing process of the playback image in fixed place/viewpoint and at arbitrary time.

FIG. 25 is a flowchart illustrating the detailed procedure of the synthesizing process of the playback image in the fixed place/viewpoint and at arbitrary time.

FIG. 26 is a flowchart illustrating a detailed procedure of a synthesizing process of a real-time image in arbitrary place/viewpoint and at arbitrary time.

FIG. 27 is a flowchart illustrating the detailed procedure of the synthesizing process of the real-time image in arbitrary place/viewpoint and at arbitrary time.

### MODE FOR CARRYING OUT THE INVENTION

An embodiment of the technology disclosed in this specification is hereinafter described in detail with reference to the drawings.

A compact information device which a user may bring out to use such as a cell phone such as a smartphone, a tablet terminal, a digital book, and a portable music player has been widespread. Also, recently, an information device mounted on a part of a user's body such as a head and an arm to be used is increasingly used. For example, there are a head mount display, a wristband type device and the like.

The information device of this type basically comes with a function of reproducing information such as video contents and audio contents and this may reproduce a moving image stored in advance and a moving image shot on site, or may reproduce a moving image through a network (including real-time streaming). Furthermore, it is also possible to assign the reproduced moving images with augmented reality (AR) information.

Also, it is supposed that ready-made contents and a moving image shot in an involuntary place are viewed with the information device of this type. For example, suppose that a user who carries the information device visits a certain place and wants to watch a past scene there. However, viewable place and contents are very limited. Also, it is required to process the contents by means of a personal computer (PC) or a dedicated player is required in order to reproduce at a high speed to rapidly find a screen which is wanted to be viewed. Furthermore, only the contents generated in advance from limited information may be presented regarding estimated future. In short, viewing of the contents is temporally and spatially limited. Conventionally, there is scarcely estimation regarding an arbitrary viewpoint and arbitrary time.

On the other hand, the technology disclosed in this specification reproduces one or combination of two or more of an image, audio, and environment information without the temporal or spatial limitation, that is to say, those in an arbitrary place and at an arbitrary time point in a content viewing system utilizing the head mount display or a portable information device provided with a display. Therefore, the user may simulatively experience temporal or spatial or temporal and spatial movement.

The content viewing system utilizing the technology disclosed in this specification also provides a function of performing chase reproduction until desired time as needed. According to this, the user does not miss information at a certain time point. Furthermore, the technology disclosed in this specification may effectively present the information to the user by realizing return to a present state as needed or presenting information obtained by combining a plurality of pieces of information. The user may develop an understanding of a situation or may experience an arbitrary time point and arbitrary position/attitude, so that the user may know a state in the place even if the user is not present in that place at that time. Also, according to the technology disclosed in this specification, it is possible to present a virtual space and a real space without inhibiting a sense of immersion by seamlessly connecting real information and virtual information at an arbitrary time point or in an arbitrary place.

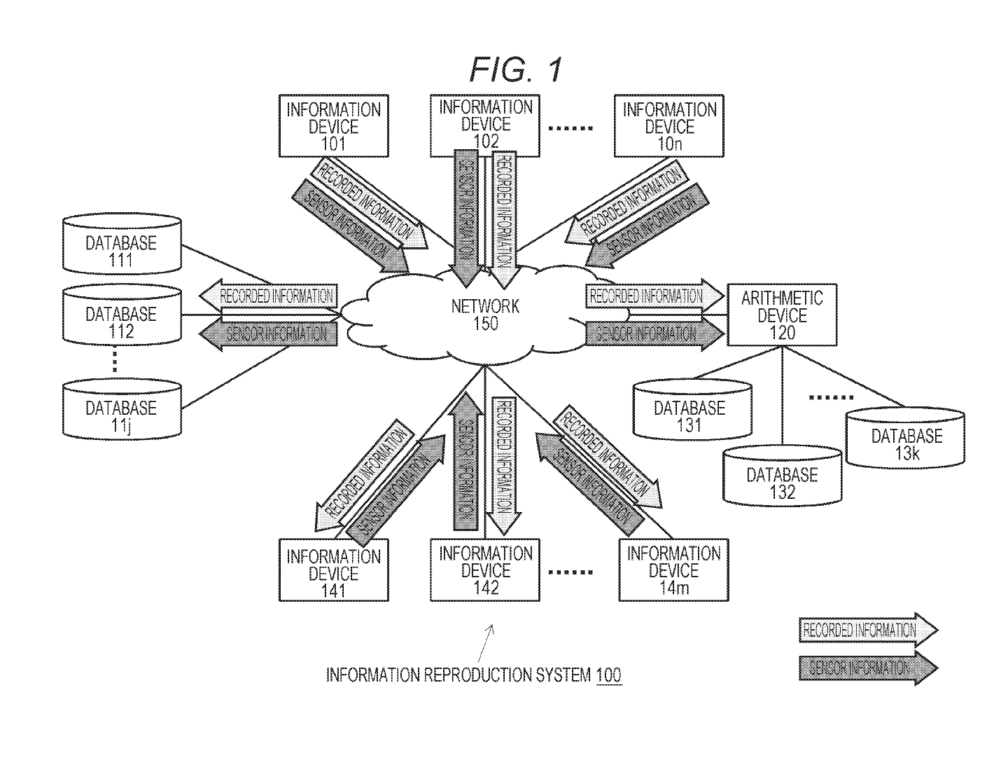

FIG. 1 schematically illustrates a configuration of an information reproduction system 100 according to one embodiment of the technology disclosed in this specification. The illustrated information reproduction system 100 is formed of one or more information devices 101, 102, . . . , and 10n each having a recording function of information to be presented to the user shared by the users, one or more databases 111, 112, . . . , and 11j which store the information recorded by the information devices 101, 102, . . . , and 10n, an arithmetic device 120 which performs an arithmetic process on the information recorded by the information devices 101, 102, . . . , and 10n, one or more databases 131, 132, . . . , and 13k which store the information after the arithmetic process by the arithmetic device 120, and one or more information devices 141, 142, . . . , and 14m each of which reproduces the recorded image and audio, or the environmental information and presents the same to the user.

The information devices 101, 102, . . . , and 10n, the databases 111, 112, . . . , and 11j, the arithmetic device 120, the databases 131, 132, . . . , and 13k, and the information devices 141, 142, . . . , and 14m are connected to one another through a wireless or wired network 150.

Each of the information devices 101, 102, . . . , and 10n which records the information presented to the user shared by the users is, for example, an image display device (head mount display) mounted on a head or a face of the user, a monitoring camera, a cell phone, a tablet terminal, a digital book, a portable imaging device and the like, and this records the information by image recording and audio recording at various times or in various places such as a place where the user mounted with the head mount display moves, a place where the monitoring camera is installed, or a place where there is the user.

The information devices 101, 102, . . . , and 10n which record the information presented to the user shared by the users record the information to be presented to the user image recorded or audio recorded at various times or in various places. Also, each of the information devices 101, 102, . . . , and 10n is provided with various sensors for obtaining position/attitude information, time, the environment information and the like. Then, the information devices 101, 102, . . . , and 10n deliver the recorded information which is image recorded or audio recorded together with sensor information such as the position/attitude information (for example, information of a line of sight when shooting) of the device at the time of recording, the time, and the environment information of the device at the time of recording through the network 150 to store in any one of the databases 111, 112, . . . , and 11j.

The information of the image or audio stored in the databases 111, 112, . . . , and 11j is shared on the network 150. The sensor information assigned to the recorded information of the image and audio includes basically the position/attitude information and time information when the information devices 101, 102, . . . , and 10n record. It is also possible to assign the environment information such as illuminance, temperature, humidity, acceleration, ultraviolet intensity, chemical substances (concentration, type, state and the like) at the time of recording to the recorded information as the sensor information other than them.

Meanwhile, a process of assigning the position/attitude information, the time, and the environment information to the recorded information such as the image and audio may be performed at the time of transmission from the information devices 101, 102, . . . , and 10n to the databases 111, 112, . . . , and 11j or after the transmission to the databases 111, 112, . . . , and 11j.

Also, the information devices 101, 102, . . . , and 10n may correct blurring when recording the image and audio, thereby improving reproduction accuracy of the image and audio (that is to say, image reproducibility, audio reproducibility, and position/attitude reproducibility) at the time of subsequent viewing. The following may be applied as a blurring correcting function.

(1) Mechanical vibration correcting mechanism around image recording and audio recording function in the information devices 101, 102, . . . , and 10n which record.

(2) Automatic blurring correction based on the sensors of the information devices 101, 102, . . . , and 10n which record and detection of periodic change in image and audio.

(3) Automatic blurring correction by detection of periodic change in image or audio to be corrected captured by another information device which records.

The arithmetic device 120 processes the recorded information which is image recorded or audio recorded by each of the information devices 101, 102, . . . , and 10n on the basis of the sensor information at the time of recording. For example, the arithmetic device 120 performs the arithmetic process for reproducing the real information at an arbitrary time point or in an arbitrary place from the pieces of information which are image recorded or audio recorded at different times or in different places by the information devices 101, 102, . . . , and 10n. The information after the arithmetic process is stored in any one of the databases 131, 132, . . . , and 13k. Also, the arithmetic device 120 performs the arithmetic process for seamlessly connecting from the real information at an arbitrary time point or in an arbitrary place stored in any one of the databases 111, 112, . . . , and 11j to imaginary information and the arithmetic process for seamlessly connecting from the imaginary information to the real information other way round. The information after the arithmetic process is stored in any one of the databases 131, 132, . . . , and 13k.

Each of the information devices 141, 142, . . . , and 14m which reproduces the recorded image and audio or the environment information to present to the user is a personal-use information device such as the image display device (head mount display) mounted on the head or the face of the user, the cell phone such as the smartphone, the tablet terminal, the digital book, the portable music player, and the portable imaging device, for example. The information devices 141, 142, . . . , and 14m are carried by the user to be used to reproduce the information reproduced by the arithmetic device 120.

The information stored in the databases 111, 112, . . . , and 11j and the databases 131, 132, . . . , and 13k is shared by the users. When reading the information stored in the databases 111, 112, . . . , and 11j or the databases 131, 132, . . . , and 13k, the information devices 141, 142, . . . , and 14m reproduce and output the same to present to the user. When the information devices 141, 142, . . . , and 14m reproduce to output the information read from the databases 131, 132, . . . , they may present the same to the user as the information reproduced at an arbitrary time point or in an arbitrary place. For example, when the reproduction of the information is requested with the sensor information such as current position and attitude of the user and the environment information, the information devices 141, 142, . . . , and 14m obtain information reproduced on the basis of the sensor information (for example, information reconfigured as an image seen in a current line of sight direction in the current position of the user) or the imaginary information seamlessly connected from the real information on the basis of the sensor information from any one of the databases 131, 132, . . . , and 13k to present to the user.

Meanwhile, it is also supposed that two or more functions of the information devices 101, 102, . . . , and 10n, the databases 111, 112, . . . , the arithmetic device 120, the databases 131, 132, . . . , and the information devices 141, 142, . . . are physically mounted on one device.

In the information reproduction system 100 illustrated in FIG. 1, the arithmetic device 120 generates the image and audio or the environment information at an arbitrary time point from a viewpoint in a place in which each of the information devices 141, 142, . . . , and 14m on a viewing side is located. The arbitrary time point includes both time before the present and time after the present. Therefore, the information devices 141, 142, . . . , and 14m may reproduce a state in the place at arbitrary time.

The information such as the image and audio generated by the arithmetic device 120 is basically the position/attitude information of a viewpoint viewing from which is wanted and the time (at which time, or an amount of time by which it goes back to the past or goes forward in the future); however, this may also be setting information of a requested reproduction quality regarding the image and audio and system control information generated on the basis of the environment information measured by the sensor mounted on the information device main body or the sensor installed outside the information device such as the illuminance, temperature, humidity, acceleration, ultraviolet intensity, chemical substances (concentration, type, state and the like).

It is also possible to generate the information generated by the arithmetic device 120 for viewing by the information devices 141, 142, . . . , and 14m by the same method as that of image recording and audio recording by the information devices 101, 102, . . . , and 10n regarding the position/attitude and time at present or at timing close to the present. That is to say, it is also possible to generate by pattern recognition and the like from the sensor information (GPS, geomagnetism, acceleration sensor, image, and audio) by a sensor unit mounted on the device or an external sensor unit.

The viewpoint position/attitude and the time with which the information devices 141, 142, . . . , and 14m want to view may be arbitrarily set by the user or automatically set according to a condition determined in advance. For example, when there is certain setting, the user is not required to set every time and it is processed such that the image and audio according to the position and attitude, and return time or advance time set in advance are reproduced depending on the line of sight of the user.

Recorded past image and past audio may be reconfigured by the information devices 101, 102, . . . , and 10n which record the image and audio or by the information devices 141, 142, . . . , and 14m which reproduce, that is to say, with which the user views in addition to the arithmetic device 120 on the network 150. Regardless of the device which reconfigures the image and audio, the device may be directly provided with an area in which the image and audio, and the position/attitude information are stored or the database may be utilized.

As already described, the position/attitude information and the time information are assigned to the information of the image or audio stored in the databases 111, 112, . . . , and 11j. In contrast, each of the information devices 141, 142, . . . , and 14m on the viewing side transmits the position/attitude information of itself (that is to say, with which the user views) to the arithmetic device 120 on the network 150 at regular intervals, or when an event such as viewing occurs, or in advance while predicting that the event such as the viewing occurs. Then, the arithmetic device 120 reconfigures the image and audio corresponding to the received position/attitude information by utilizing the information of the image or audio stored in the databases 111, 112, . . . , and 11j and transmits the same to the information devices 141, 142, . . . , and 14m on the viewing side.

Also, when not the past image and audio are played back but future image and audio are presented, the arithmetic device 120 estimates the future image and audio from difference between a certain time point and a certain time point, for example, by utilizing the information of the image or audio stored in the databases 111, 112, . . . , and 11j and transmits the same to the information devices 141, 142, . . . , and 14m on the viewing side.

When the information devices 141, 142, . . . , and 14m on the viewing side set the amount by which it goes back to the past or the amount by which it goes forward in the future in time in advance or arbitrarily set at the time of viewing, they transmit such time information to the arithmetic device 120 on the network 150. Regarding the time, for example, the information devices 141, 142, . . . , and 14m on the viewing side or the information devices 101, 102, . . . , and 10n on the recording side are allowed to put a mark in advance to a certain time point or a plurality of time points of the recorded image and audio and the marked time point may be made a reproduction point. It is also possible that the mark is set at an arbitrary time point, or that the information devices 141, 142, . . . , and 14m on the viewing side or the information devices 101, 102, . . . , and 10n on the recording side set the same in advance, or that the setting itself is automated and the mark is automatically put to the time of the point matching the setting.

As a method of generating the time to which the mark is automatically put, the recorded image and audio may be analyzed to be listed according to objects. For example, there is a method of extracting a point at which state transition is found the most in the image and components in an acoustic field from the information of the recorded image and audio as information indicating a change point when the recorded image and audio are analyzed and the change point is detected. A list of time such as when the number of component audio sources is the largest, when intensity of the audio source is high, and when a range of the audio source is frequently found on a high-pitch side as important points is created, and it is automatically marked according to the objects. Meanwhile, it is also possible to merely extract a specific state while narrowing the objects in advance without creating the list.

The arithmetic device 120 loads data of the image and audio around the position information and around the time transmitted from the information devices 141, 142, . . . , and 14m on the viewing side from the information devices 141, 142, . . . , and 14m on the viewing side. Then, in the arithmetic device 120, the image and audio from a viewing viewpoint are reconfigured on the basis of the position information and attitude information. Then, the information devices 141, 142, . . . , and 14m on the viewing side reproduce the reconfigured image and audio while loading the same into an internal memory through the network 150. In this manner, the information devices 141, 142, . . . , and 14m on the viewing side may view the image and audio in the place at an arbitrary time point.

Meanwhile, in the configuration example of the information reproduction system 100 illustrated in FIG. 1, it is configured to reconfigure the image and audio viewed by the information devices 141, 142, . . . , and 14m by a single arithmetic device 120; however, it is also possible that a series of processes for reconfiguring is performed by a plurality of devices in a distributed manner.

As described above, the information reproduction system 100 according to this embodiment may access information of the past image and audio in the place where there is the user who carries the information devices 101, 102, . . . , and 10n having the image recording/audio recording function or the place where the information devices 101, 102, . . . , and 10n are installed. Therefore, the information devices 141, 142, . . . , and 14m on the viewing side may view the image and audio at many viewing points and view the past state at the viewing point in the place in a wide area. Furthermore, it is possible to return to a current situation while confirming the state in the place in the past by applying high-speed reproduction technology to the shot moving image (for example, refer to Patent Document 2).

As a variation of the information reproduction system 100 which reproduces the information at an arbitrary time point and in an arbitrary place without the temporal or spatial limitation, it is also possible to present not the information of the real image and audio actually recorded by the information devices 101, 102, . . . , and 10n on the recording side but the imaginary information generated on the basis of the actual recorded information. In this case, the arithmetic device 120 generates an imaginary configuration from the real image at a certain time point and in certain position/attitude in the real through arithmetic operation and combines an imaginary scene and a real scene without a sense of discomfort. Specifically, it becomes possible to move between the real space and the virtual space without giving a sense of discomfort to the user and give a deeper sense of immersion by a process of gradually making a temporally or spatially or temporally and spatially imaginary scene the real scene.

The information devices 141, 142, . . . , and 14m on the viewing side may also display displays from the viewpoints of different times and different positions/attitudes in a full screen. Alternatively, this may combine a current view with any one or two or more of views in the past and future, the views from the viewpoints of different positions/attitudes to display in parallel. This may also superimpose the current view on any one or combination of two or more of the views in the past and future, and the views from the viewpoints of the different positions/attitudes to display.

Also, the information devices 141, 142, . . . , and 14m on the viewing side may similarly combine the current information with one or two or more pieces of information in the past and future, and in the different positions/attitudes to present not only when presenting the image but also when presenting the audio and other sensor information. For example, it is also possible to daringly combine the image seen from a certain viewpoint with an audio image which is not recorded from the viewpoint. On the other hand, it is also possible to combine the audio image recorded from the viewpoint with the image seen from another viewpoint. It is also possible to daringly combine a certain time point with the audio images recorded before and after the same to present.

A dedicated database server or a server of a moving image sharing site may be used as one or more databases 111, 112, . . . which store the information recorded by the information devices 101, 102, . . . , and 10n and one or more databases 131, 132, . . . which store the information after the arithmetic process by the arithmetic device 120. For example, the information devices 101, 102, . . . , and 10n on the recording side upload the recorded information of the image and audio into the server of the moving image sharing site together with the position/attitude, time, and other sensor information. Also, when the arithmetic device 120 obtains the desired information of the image and audio from the server of the moving image sharing site on the basis of the position/attitude and time information, this performs the arithmetic process and loads the generated information of the image and audio into the information devices 141, 142, . . . , and 14m on the viewing side and uploads into the server of the moving image sharing site.

In this embodiment, generation timing of the position/attitude and time information is not limited even with the information of the image and audio in which the position/attitude and time information are not set. The arithmetic device 120 may estimate the position, attitude, and time by using image recognition technology from the image and the image and audio in the acoustic field, extract the same as the position, attitude, and time information at the time of recording, and assign to the image and audio recorded in the databases 111, 112, . . . , and 11j. According to this method, it becomes possible to utilize existing information of the image and audio accumulated in the server of the moving image sharing site from before which is not recorded by the information devices 101, 102, . . . , and 10n on the recording side in the information reproduction system 100 by estimating the position, attitude, and time information and assign to the same.

Meanwhile, there also is the moving image sharing site which provides a service of writing a comment input by another user, an automatically input comment, or other input information in the image (for example, refer to Patent Document 3). The comment written in the image is mainly a note, an explanation, a review, a criticism, an opinion and the like. As described above, when the existing image uploaded into the server of the moving image sharing site is utilized by the information reproduction system 100, when arithmetic operation of the information of the image and audio is performed by the arithmetic device 120, or when loading the same into the information devices 141, 142, . . . , and 14m on the viewing side, the input information may be reflected in the image and audio. For example, the arithmetic device 120 may realize a recommending function of extracting the viewing point at which the users frequently write the comments in the moving image as a recommended reproduction viewing point to feed back to the information devices 141, 142, . . . , and 14m on a reproduction side.

It is also possible to input the comment and other information when uploading the recorded image and audio from the information devices 101, 102, . . . , and 10n on the recording side into the moving image sharing site. The input information may also be a target to be processed similar to the comment input by the user or the automatically input comment on the moving image sharing site and other input information.

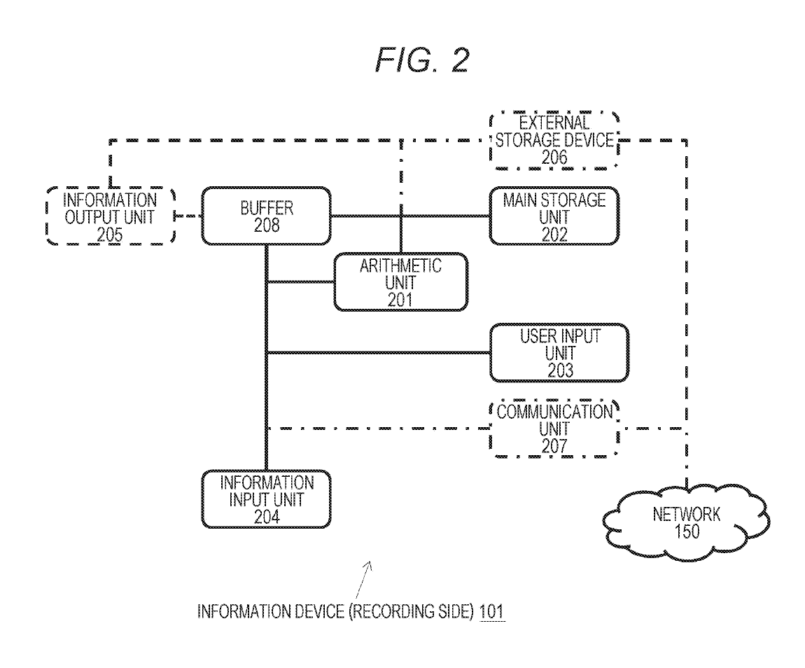

FIG. 2 illustrates an internal configuration example of the information device 101 which records the information presented to the user. It should be understood that other information devices 102, 103, . . . , and 10n which record the information also have the similar configurations. In the drawing, a component indispensable for the information device 101 is indicated by solid line, an arbitrary component is indicated by dotted line, and components at least one of which should be provided are indicated by dashed-dotted line.

The information device 101 is provided with an information input unit 204 which inputs the information to be recorded as the indispensable component in addition to basic components of a computer such as an arithmetic unit 201, a main storage unit 202, and a user input unit 203. The information device 101 may also be provided with an information output unit 205 which reproduces and outputs the recorded information to present to the user as the arbitrary component. The information input unit 204 and the information output unit 205 are described later in detail.

Furthermore, the information device 101 is provided with an external storage device 206 or a communication unit 207 as the arbitrary component of the computer. The external storage device 206 formed of a large-capacity storage device such as a hard disk drive may be used as the database 111 or 131, for example, for storing the recorded information. Also, the communication unit 207 formed of a wired or wireless local area network (LAN) interface, for example, is used for connecting to an external device through the network 150. The external device herein includes the databases 111, 112, . . . , and 11j, the arithmetic device 120, the databases 131, 132, . . . , and 13k, and the information devices 141, 142, . . . , and 14m. The information device 101 is required to be provided with at least one of the external storage device 206 and the communication unit 207 for recording the information input by the information input unit 204 to present to the user. The information input unit 204 and the information output unit 205 are connected to the external storage device 206 or the communication unit 207 through a buffer 208.

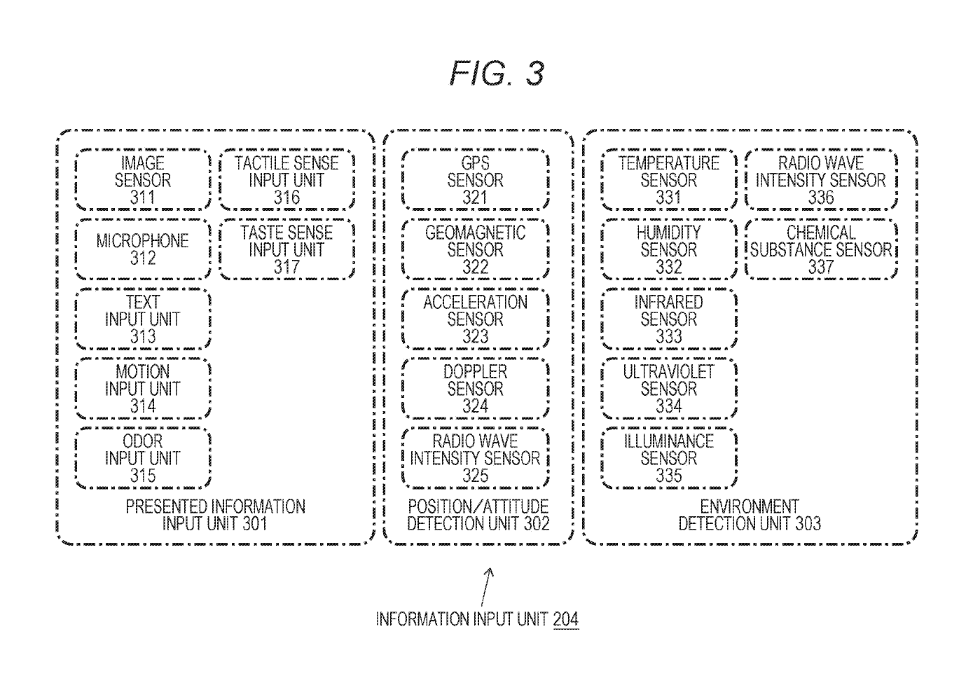

FIG. 3 illustrates an internal configuration example of the information input unit 204 which inputs the information to be recorded. In the illustrated example, the information input unit 204 is provided with a presented information input unit 301 which inputs the information presented to the user, a position/attitude detection unit 302 which detects the position/attitude information of the device at the time of recording, and an environment detection unit 303 which detects an environment of the device at the time of recording. The information input unit 204 is provided with at least one of the presented information input unit 301, the position/attitude detection unit 302, and the environment detection unit 303 and the components 301 to 303 are indicated by dashed-dotted line in FIG. 3.

The presented information input unit 301 provided with at least one of an image sensor 311 for inputting the image to be recorded, a microphone 312 for inputting the audio to be recorded, a text input unit 313 for inputting a character string, a motion input unit 314 for inputting a motion such as a gesture, an odor input unit 315, a tactile sense input unit 316, and a taste sense input unit 317 inputs at least one of the image, the audio, character information, the motion, odor, a tactile sense, and a taste sense as the presented information to be presented to or shared with other users. In FIG. 3, the components 311 to 316 are indicated by dashed-dotted line.

The position/attitude detection unit 302 is provided with at least one of a global positioning system (GPS) 321, a geomagnetic sensor 322, an acceleration sensor 323, a Doppler sensor 324, and a radio field intensity sensor 325 in order to detect the position and attitude of the information device 101. In FIG. 3, the components 321 to 325 are indicated by dashed-dotted line.

Meanwhile, at least a part of the sensors forming the position/attitude detection unit 302 is supposed to be installed not in the information input unit 204 (that is to say, in the information device) but outside the same. It is also possible to generate the information of the position and attitude not from detection results of the above-described sensors but by pattern recognition and the like of the image or audio input by the presented information input unit 301.

The environment detection unit 303 is provided with at least one of environment sensors such as a temperature sensor 331, a humidity sensor 332, an infrared sensor 333, an ultraviolet sensor 334, an illuminance sensor 335, a radio field intensity sensor 336, and a chemical substance (concentration, type, and state) sensor 337 in order to detect the environment of the information device 101. In FIG. 3, the components 331 to 337 are indicated by dashed-dotted line.

Meanwhile, at least a part of the environment sensors which form the environment detection unit 303 is supposed to be installed not in the information input unit 204 (that is to say, in the information device) but outside the same.

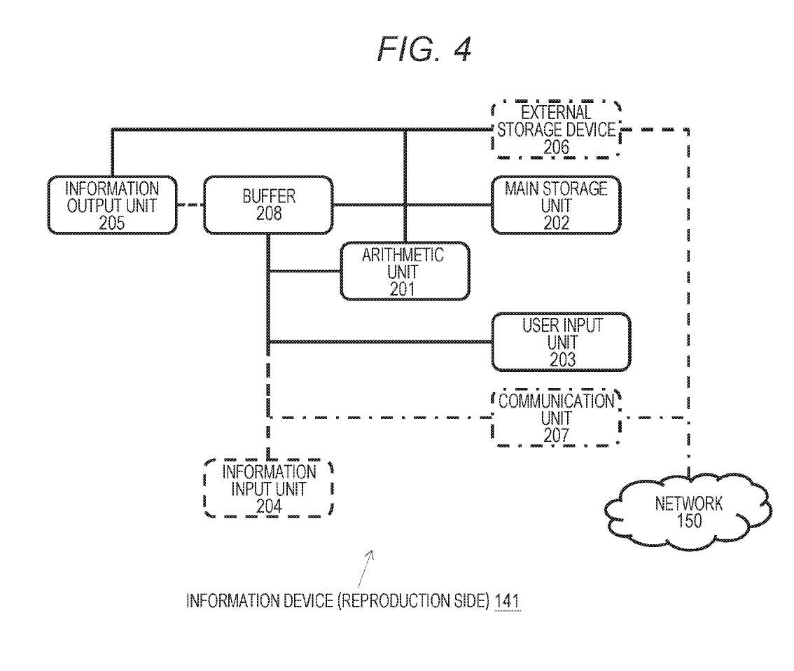

FIG. 4 illustrates an internal configuration example of the information device 141 which presents the recorded information to the user. It should be understood that other information devices 142, 143, . . . , and 143m which present the information also have the similar configurations. In the drawing, the same reference numeral is assigned to the same component as that illustrated in FIG. 2. Also, a component indispensable for the information device 141 is indicated by solid line, an arbitrary component is indicated by dotted line, and components at least one of which should be provided are indicated by dashed-dotted line.

The information device 141 is provided with the information output unit 205 which reproduces and outputs the recorded information to present to the user as the indispensable component in addition to the basic components of the computer such as the arithmetic unit 201, the main storage unit 202, and the user input unit 203. The information device 141 may also be provided with the information input unit 204 which inputs the information to be recorded as the arbitrary component. The information input unit 204 is as described with reference to FIG. 3. Also, the information output unit 205 is described later in detail.

Furthermore, the information device 141 is provided with the external storage device 206 or the communication unit 207 as the arbitrary component of the computer. The external storage device 206 formed of a large-capacity storage device such as a hard disk drive may be used as the database 111 or 131, for example, for reading the recorded information. Also, the communication unit 207 formed of a wired or wireless LAN interface, for example, is used for connecting to the external device through the network 150. The external device herein includes the information devices 101, 102, . . . , and 10n, the databases 111, 112, . . . , and 11j, the arithmetic device 120, and the databases 131, 132, . . . , and 13k. The information device 141 is required to be provided with at least one of the external storage device 206 and the communication unit 207 for reproducing the recorded information to present to the user. The information input unit 204 and the information output unit 205 are connected to the external storage device 206 or the communication unit 207 through a buffer 208.

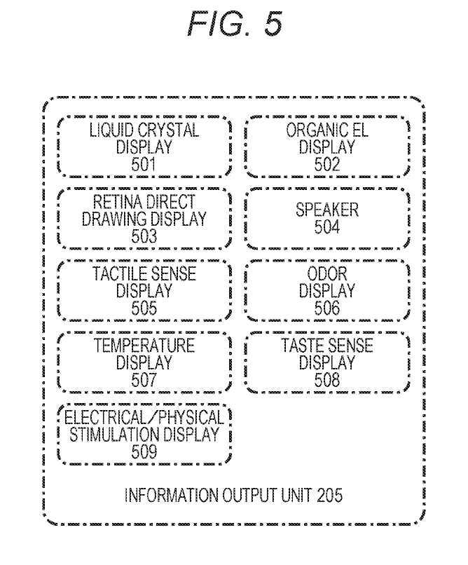

FIG. 5 illustrates an internal configuration example of the information output unit 205 which reproduces and outputs the recorded information to present to the user. In the illustrated example, the information output unit 205 is provided with at least one of a liquid crystal display 501, an organic EL display 502, and a retina direct drawing display 503 each of which displays the presented information, a speaker 504 which audio-outputs the presented information, a tactile sense display 505 which outputs the presented information by the tactile sense, an odor display 506 which outputs an odor component of the presented information, a temperature display 507 which outputs a temperature component of the presented information, a taste sense display 508 which presents the taste sense, and an (electrical/physical stimulation) display 509 by electrical/physical stimulation to each sensory organ and the brain. In FIG. 5, the components 501 to 509 are indicated by dashed-dotted line.

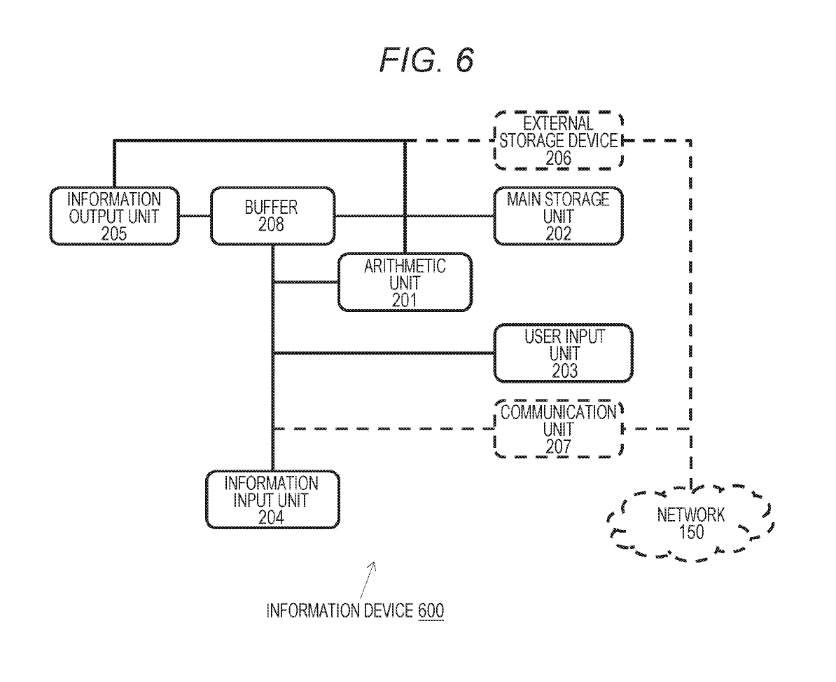

Also, FIG. 6 illustrates an internal configuration example of a stand-alone information device 600 which inputs the information to be recorded, records the information, and reproduces and outputs the recorded information. The information device 600 is provided with the functions of the information devices 101 and 141. In the drawing, the same reference numeral is assigned to the same component as that illustrated in FIG. 2. Also, an indispensable component is indicated by solid line, an arbitrary component is indicated by dotted line, and components at least one of which should be provided are indicated by dashed-dotted line.

The information device 141 is provided with the information input unit 204 which inputs the information to be recorded and the information output unit 205 which reproduces and outputs the recorded information to present to the user as the indispensable components in addition to the basic components of the computer such as the arithmetic unit 201, the main storage unit 202, and the user input unit 203. The information input unit 204 is as described with reference to FIG. 3. Also, the information output unit 205 is as described with reference to FIG. 5.

The arithmetic unit 201 executes a predetermined application, for example, to perform the process similar to that of the arithmetic device 120. That is to say, the information input to the presented information input unit 301 in the information input unit 204 is processed on the basis of the sensor information of the position/attitude detection unit 302 and the environment detection unit 303 at the time of input.

For example, the arithmetic unit 201 performs the arithmetic process for reproducing the real information at different time or in a different place from the information which is image recorded or audio recorded at arbitrary time or in an arbitrary place. The information after the arithmetic process is stored in the external storage device 206 in the information device 600 or stored in any one of the databases 131, 132, . . . , and 13k on the network 150 through the communication unit 207. The arithmetic unit 201 also performs the arithmetic process for seamlessly connecting from the real information at an arbitrary time point or in an arbitrary place stored in the external storage device 206 (or any one of the databases 111, 112, . . . , and 11j) to the imaginary information and the arithmetic process for seamlessly connecting from the imaginary information to the real information other way round.

Furthermore, the information device 600 is provided with the external storage device 206 or the communication unit 207 as the arbitrary component of the computer. The external storage device 206 formed of a large-capacity storage device such as a hard disk drive may be used as the database 111 or 131, for example, for reading the recorded information. Also, the communication unit 207 formed of a wired or wireless LAN interface, for example, is used for connecting to the external device through the network 150. The external device herein includes the information devices 101, 102, . . . , and 10n, the databases 111, 112, . . . , and 11j, the arithmetic device 120, and the databases 131, 132, . . . , and 13k. The information device 101 is required to be provided with at least one of the external storage device 206 and the communication unit 207 for reproducing the recorded information to present to the user. The information input unit 204 and the information output unit 205 are connected to the external storage device 206 or the communication unit 207 through a buffer 208.

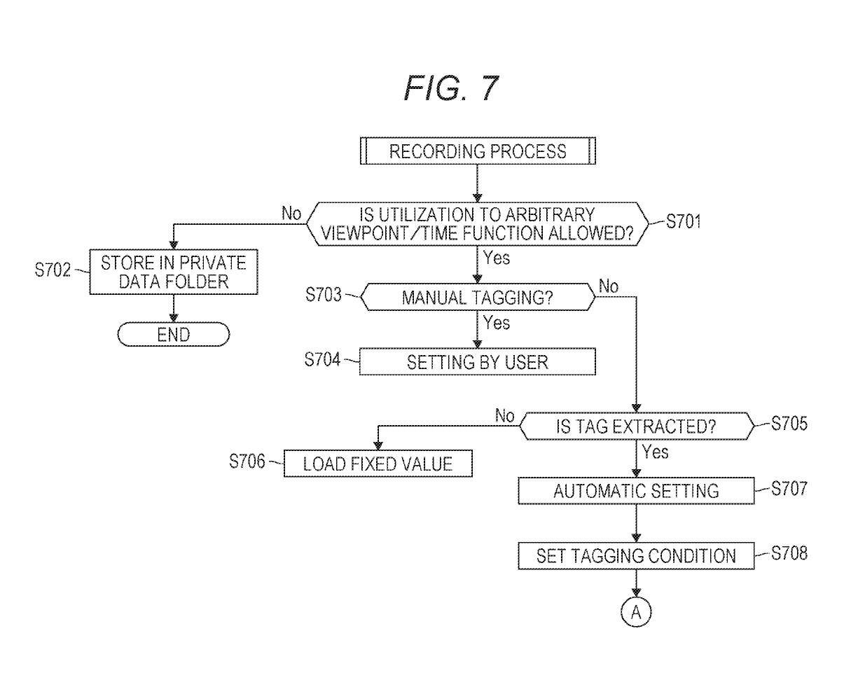

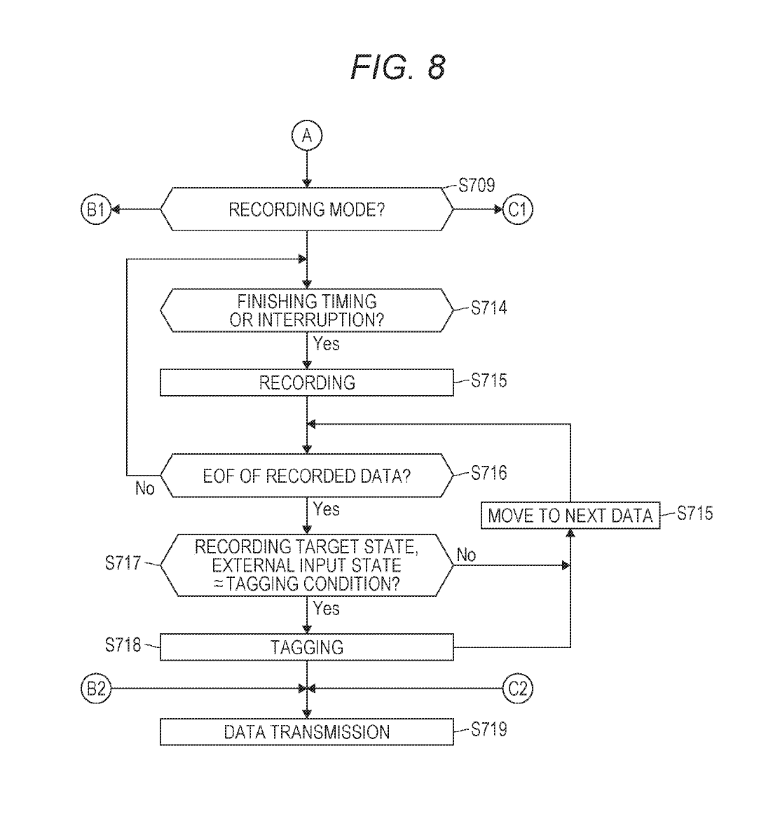

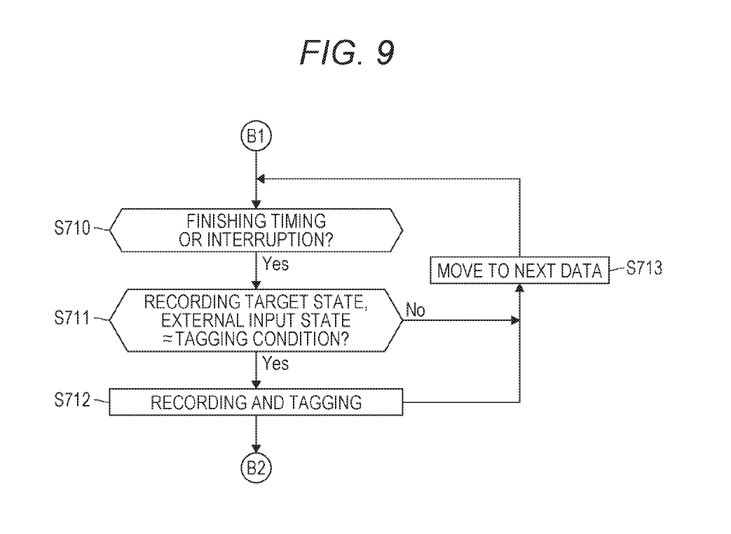

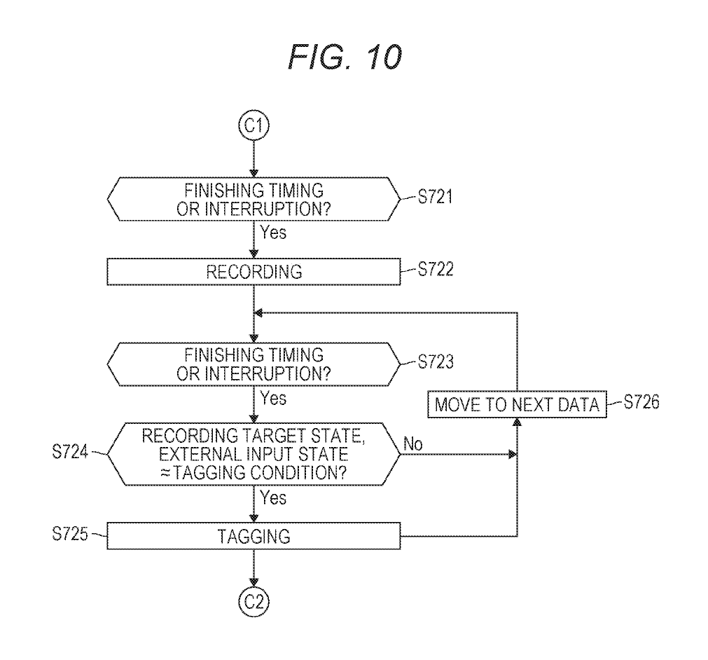

FIGS. 7 to 10 illustrate an example of a basic process executed by the information devices 101, 102, . . . , and 10n on the recording side in a flowchart format.

When the information device 101 performs a recording process, this first checks whether usage of the recorded image or the recorded audio in an arbitrary viewpoint/time function is allowed (S701).

When the usage of the recorded image or the recorded audio in the arbitrary viewpoint/time function is not allowed (No at step S701), the information device 101 stores the image or audio in a private data folder in an image device, for example (step S702), and finishes this processing routine.

On the other hand, when the usage of the recorded image or the recorded audio in the arbitrary viewpoint/time function is allowed (Yes at step S701), the information device 101 subsequently checks whether manually tagging is performed (step S703).

When the manually tagging is performed (Yes at step S703), it is set by the user (step S704).

When the manually tagging is not performed (No at step S703), it is checked whether a tag is extracted (step S705). Then, when the tag is not extracted (No at step S705), a fixed value is loaded (step S706). Also, when the tag is extracted (Yes at step S705), it is automatically set (step S707) and a tagging condition is set (step S708).

Next, the information device 101 checks a recording mode of the image and audio (step S709). For example, the recording mode is determined according to following conditions.

(1) It is wanted that . . . listens to this.

(2) An edge of a component is not smaller than a certain threshold.

(3) A tire of a vehicle is worn out.

(4) A break is put.

(5) Half time (fixed timing: agenda program).

(6) Power point is used.

(7) A particular keyword is shouted repeatedly.

(8) A watch is seen.

(9) Most frequent keyword.

In a first recording mode, at finishing timing or when interruption occurs (Yes at step S710), if a recording target state and an external input state are substantially equal to the tagging condition set at step S708 (Yes at step S711), the information device 101 records the image and audio and tags (step S712), and then shifts to next data (step S713).

Also, in a second recording mode, at the finishing timing or when the interruption occurs (Yes at step S714), the information device 101 records the image and audio (step S715). Then, when it reaches an end of file (EOF) of the recorded data (Yes at step S716), if the recording target state and the external input state are substantially equal to the tagging condition set at step S708 (Yes at step S717), the information device 101 records the image and audio and tags (step S718), and then shifts to next data (step S720).

Also, in a third recording mode, at the finishing timing or when the interruption occurs (Yes at step S721), the information device 101 records the image and audio (step S722). Then, at the finishing timing or when the interruption occurs (Yes at step S723), if the recording target state and the external input state are substantially equal to the tagging condition set at step S708 (Yes at step S724), the information device 101 records the image and audio and tags (step S725), and then shifts to next data (step S726).

Then, the information device 101 transmits the recorded data to the databases 111, 112, . . . , and 11j to store (step S719).

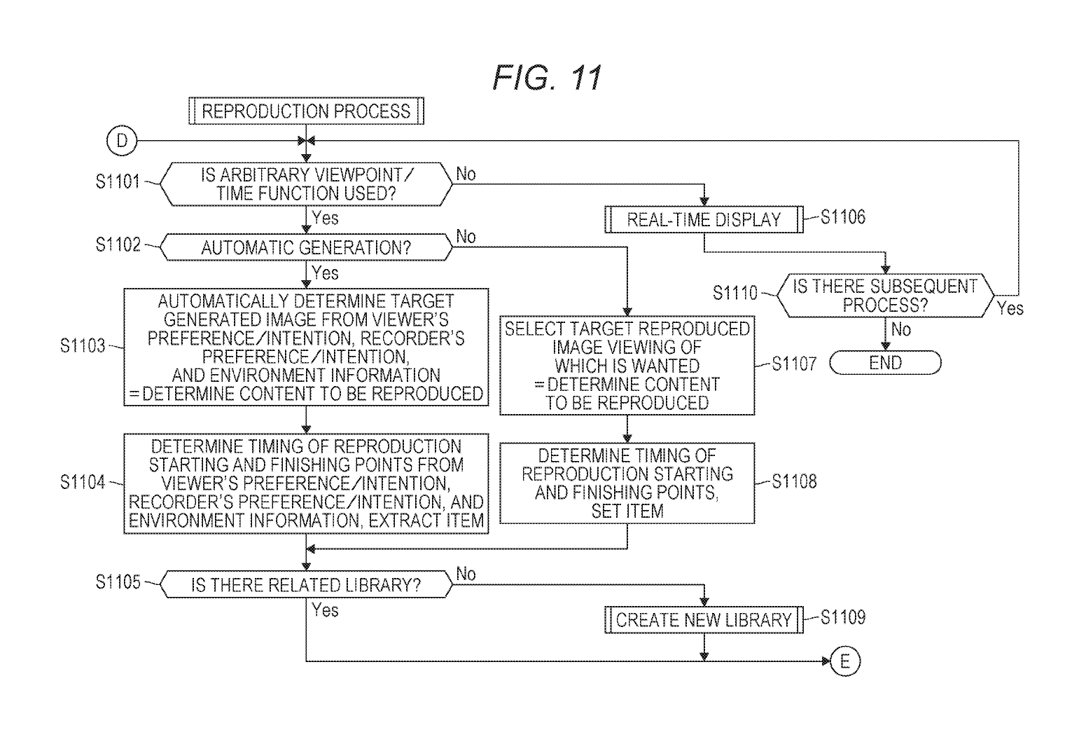

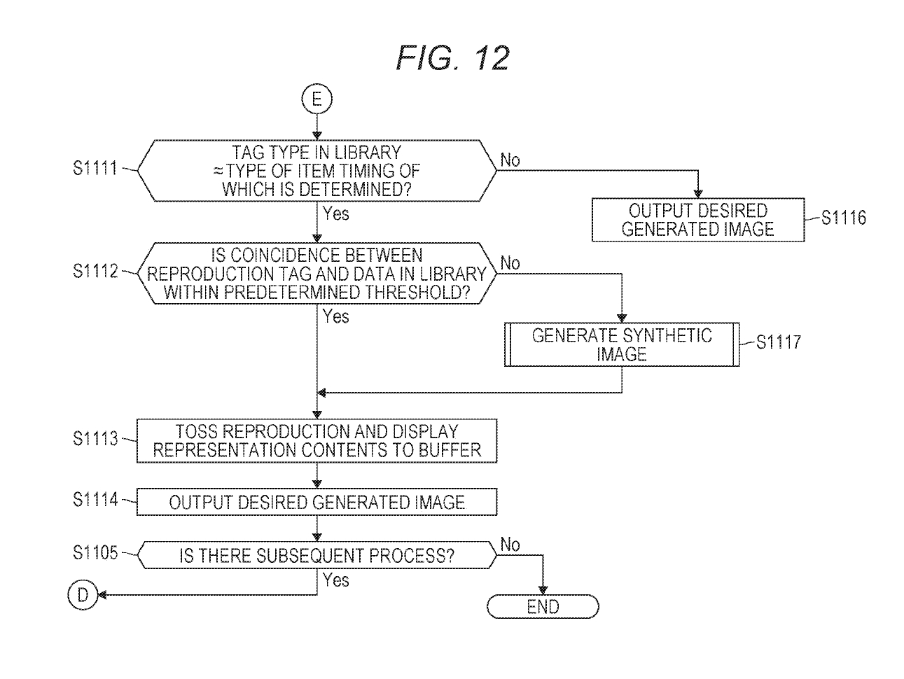

FIGS. 11 and 12 illustrate an example of a basic process executed by the arithmetic device 120 for viewing the image and audio by the information devices 141, 142, . . . , and 14m on the viewing side in a flowchart format. Note that the procedure may also be directly executed by each of the information devices 141, 142, . . . , and 14m on the viewing side.

When the information device 141 performs a reproduction process, this first checks whether the arbitrary viewpoint/time function of the recorded image or the recorded audio is used (S1101).

When the arbitrary viewpoint/time function of the recorded image or the recorded audio is not used (No at step S1101), the information device 141 displays a real-time image (step S1106). Then, if there is a subsequent process (Yes at step S1110), the procedure returns to step S1101, and if there is no subsequent process (No at step S1110), this processing routine is finished.

On the other hand, when the arbitrary viewpoint/time function of the recorded image or the recorded audio is used (Yes at step S1101), the information device 141 checks whether the image and audio are automatically generated (step S1102).

When the image and audio are automatically generated (Yes at step S1102), the information device 141 automatically determines a target generated image from viewer's preference/intention, recorder's preference/intention, and the environment information (step S1103). That is to say, a content to be reproduced is determined. Next, timings of reproduction starting point and finishing point are determined from the viewer's preference/intention, the recorder's preference/intention, and the environment information, and an item is extracted (step S1104).

Also, when the image and audio are not automatically generated (No at step S1102), the information device 141 selects a target reproduced image viewing of which is wanted (step S1107). That is to say, the content to be reproduced is determined. Then, the timings of the reproduction starting point and finishing point are determined and the item is set (step S1108).

Next, it is checked whether there is a related library (step S1105). When there is no related library, the information device 141 generates a new library (step S1109).

Next, it is checked whether a tag type in the library is substantially equal to a type of the item the timing of which is determined (step S1111).

When the tag type in the library is not equal to the type of the item the timing of which is determined (No at step S1111), the information device 141 generates a new type of the tag (step S1116). Also, when the tag type in the library is substantially equal to the type of the item the timing of which is determined (Yes at step S1111), the information device 141 further checks whether coincidence between a reproduction tag and the data in the library is within a predetermined threshold (step S1112). When the coincidence between the reproduction tag and the data in the library is not within the predetermined threshold (No at step S1112), the information device 141 generates a synthetic image (step S1117).

Next, the information device 141 tosses reproduction and display representation contents to the buffer (step S1113). Next, this outputs a desired generated image (step S1114). Then, if there is a subsequent process (Yes at step S1115), the information device 141 returns to step S1101 and repeatedly executes the above-described process. Also, if there is no subsequent process (No at step S1115), this processing routine is finished.

The tag is attached at steps S712, S718, S728 and the like when it is wanted that someone listens to at the time of recording. At the time of tagging, keyword registration and automatic determination are performed. The tag includes a brain wave tag, a frequently shouted keyword tag and the like. The tag is attached to a required place from the video. It is required to consider how to determine a starting point and a finishing point. Further, when the image is reproduced (synthesized) up to a tagged time point, a function of preventing fabrication is required. Note that a synthesizing process is described later in detail. Also, meta information regarding an image reproducing method such as highlighted reproduction, normal-speed reproduction, and double-speed reproduction may be attached to the tag. Other meta information is exemplified hereinafter.

(1) Change in Audio Volume

(2) Change in Audio Source

(3) Manual Input

(4) Device Operation

(5) Change in Brain Wave Level

(6) Change in State of Mind

(7) Room Entry and Exit

(8) Occurrence of Registered Keyword

(9) Line of Sight Gazing

(10) Eyeglasses Serve as Base Point

(11) Viewer/Shooter

When the coincidence between the reproduction tag and the data in the library is not within the predetermined threshold at the time of reproduction (No at step S1112), it catches up the time point of the reproduction tag at a high speed by generating the synthetic image at step S1117. The synthesizing process of the reproduced image having the fabrication preventing function is different from simple chase reproduction.

As for the synthesizing process of the image, the image is synthesized such that a certain person transforms to another person or a character in animation transforms to another character by utilizing image processing technology such as morphing and cross sensing. There also is a problem of how to synthesize a plurality of images and audios of different specifications.

A reproducing manner such as UP/Down CONVERT is also a target to be controlled. For example, it is set to DOWN in a glancing mode and set to UP when zooming. As an attention point by the police, UP is set for detail and DOWN is set for appearance. Further, the reproducing manner is controlled for each viewer of an object to be reproduced.

Other points to note in the method of generating the reproduced image and audio are as follows.

(1) A Method of displaying of the moving image sharing site is used.

(2) A scene in which many people look at a watch indicates amusingness or boredom of presentation.

(3) Like a map site, a particle size of the information to be presented is controlled according to a scale.

(4) Viewing angle and resolution, a vehicle comes and moves in this manner.

(5) Adistant future to a certain degree is predicted. For example, weather information and the like accuracy of which is not strictly required is predicted to be used for reproducing the image and audio.

(6) A manner of displaying a temporal multiple-view image (by means of small windows or by superimposing).

(7) An actually shot image is utilized to virtually display. For example, an image synthesizing method is changed according to types of terminals such as an in-vehicle terminal and a wearable terminal.

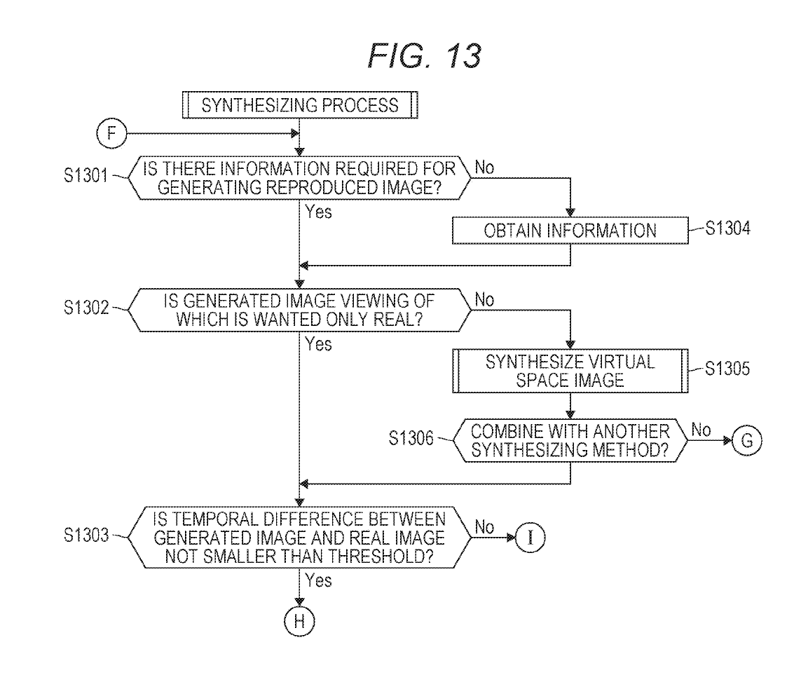

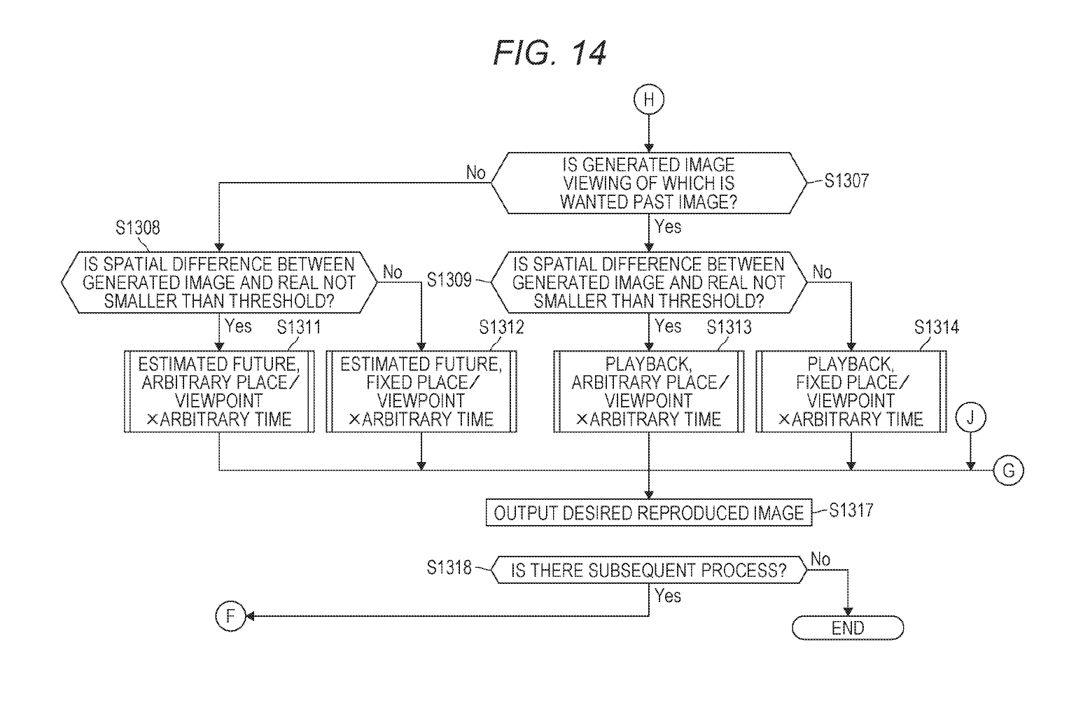

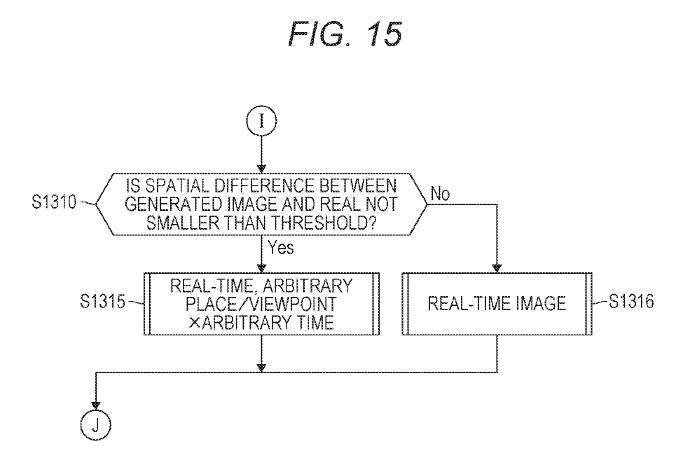

FIGS. 13 to 15 illustrate a procedure of generating the synthetic image executed at step S1117 of the flowchart illustrated in FIGS. 11 and 12 in a flowchart format.

When there is information required for generating the reproduced image (Yes at step S1301), the information device 141 obtains such information (step S1304).

Next, the information device 141 checks whether the generated image which the user of the information device on the viewing side wants to view is only the real image (step S1302).

Herein, when the generated image which the user wants to view includes not only the real image (No at step S1302), the information device 141 executes a synthesizing process of a virtual space image (step S1305). The synthesizing process of the virtual space image is described later in detail. Then, when the synthesized space image is not combined with another synthesizing method (No at step S1306), the information device 141 shifts to step S1317 and outputs the generated image.

When the generated image which the user wants to view is only the real image (Yes at step S1302) and when the virtual space image is combined with another synthesizing method (Yes at step S1306), the information device 141 subsequently checks whether temporal difference between the generated image and the real image is not smaller than a threshold (step S1303).

When the temporal difference between the generated image and the real image is not smaller than the threshold (Yes at step S1303), the information device 141 subsequently checks whether the generated image which the user wants to view is a past image (step S1307).

When the generated image which the user wants to view is not the past image (No at step s1307), the information device 141 further checks whether spatial difference between the generated image and the real is not smaller than a threshold (step S1308).

When the spatial difference between the generated image and the real is not smaller than the threshold (Yes at step S1308), the information device 141 performs a generation process of an estimated future image in arbitrary place/viewpoint and at arbitrary time (step S1311). The generation process of the estimated future image in arbitrary place/viewpoint and at arbitrary time is described later in detail.

Further, when the spatial difference between the generated image and the real is smaller than the threshold (No at step S1308), the information device 141 performs the generation process of the estimated future image in fixed place/viewpoint and at arbitrary time (step S1312). The generation process of the estimated future image in the fixed/arbitrary place/viewpoint and at arbitrary time is described later in detail.

When the generated image which the user wants to view is the past image (Yes at step s1307), the information device 141 further checks whether the spatial difference between the generated image and the real is not smaller than a threshold (step S1309).

When the spatial difference between the generated image and the real is not smaller than the threshold (Yes at step S1309), the information device 141 performs a generation process of a playback image in arbitrary place/viewpoint and at arbitrary time (step S1313). The generation process of the playback image in arbitrary place/viewpoint and at arbitrary time is described later in detail.

Also, when the spatial difference between the generated image and the real is smaller than the threshold (No at step S1309), the information device 141 performs the generation process of the playback image in fixed place/viewpoint and at arbitrary time (step S1314). The generation process of the playback image in the fixed/arbitrary place/viewpoint and at arbitrary time is described later in detail.

On the other hand, when the temporal difference between the generated image and the real image is smaller than the threshold (No at step S1303), the information device 141 further checks whether the spatial difference between the generated image and the real is not smaller than a threshold (step S1310).

When the spatial difference between the generated image and the real is not smaller than the threshold (Yes at step S1310), the information device 141 performs a generation process of the real-time image in arbitrary place/viewpoint and at arbitrary time (step S1315). The generation process of the real-time image in arbitrary place/viewpoint and at arbitrary time is described later in detail.

Also, when the spatial difference between the generated image and the real is smaller than the threshold (No at step S1310), the information device 141 performs the generation process of the real-time image (step S1316).

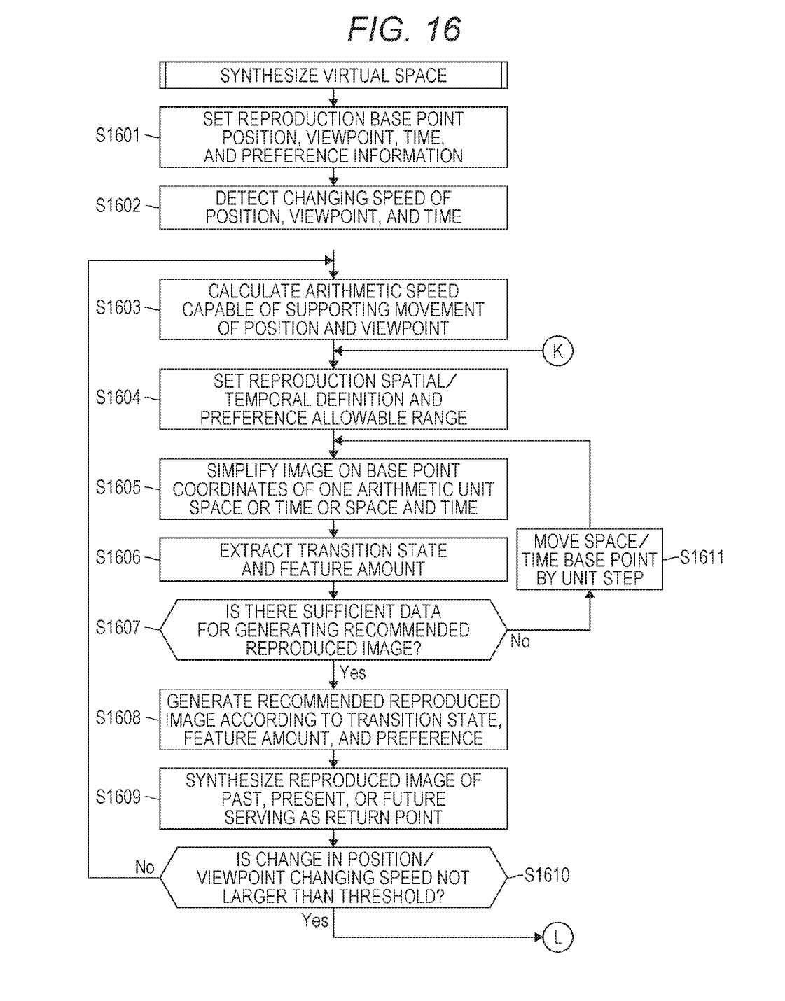

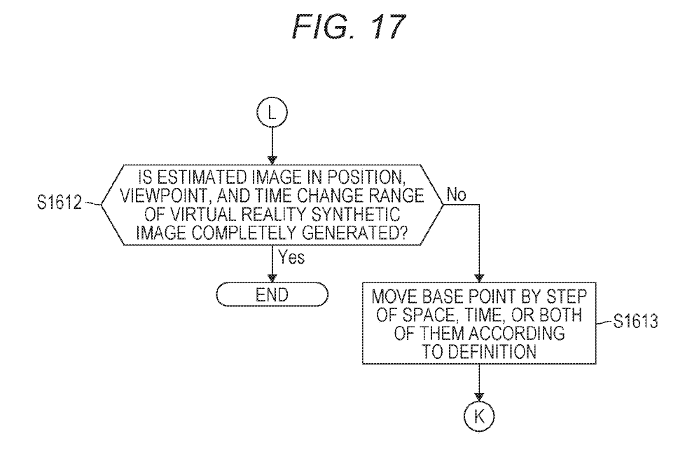

FIGS. 16 and 17 illustrate a detailed procedure of the synthesizing process of the virtual space image executed at step S1305 of the flowchart illustrated in FIGS. 13 to 15 in a flowchart format.

The information device 141 first sets reproduction base point position, viewpoint, time, and user's preference information (step S1601).

Next, the information device 141 detects a changing speed of the position, the viewpoint, and the time (step S1602).

Next, the information device 141 calculates an arithmetic speed capable of supporting movement of the position and the viewpoint (step S1603).

Next, the information device 141 sets reproduction spatial/temporal definition and a preference allowable range (step S1604).

Next, the information device 141 simplifies an image on base point coordinates of one arithmetic unit space or time or space and time (step S1605).

Next, the information device 141 extracts a transition state and a feature amount (step S1606).

Then, the information device 141 checks whether there is sufficient data for generating a recommended reproduced image (step S1607).

When there is not sufficient data for generating the recommended reproduced image (No at step S1607), the information device 141 moves a base point of space and time by a unit step (step s1611) and returns to step S1605 to repeat the similar process.

Also, when there is the sufficient data for generating the recommended reproduced image (Yes at step S1607), the information device 141 generates the recommended reproduced image according to the transition state, the feature amount, and the preference (step S1608).

Next, the information device 141 synthesizes the reproduced image in the past, present, or future serving as a return point (step S1609). Note that the synthesizing process in which an arithmetic load is decreased with accuracy decreased from that of the synthesizing process at steps S1611 to S1615 is applied to the synthesizing process at step S1609.

Next, the information device 141 checks whether change in position/viewpoint changing speed is not larger than a threshold (step S1610).

When the change in position/viewpoint changing speed is larger than the threshold (No at step S1610), the procedure returns to step S1603 and the process similar to the above-described process is repeatedly executed.

Also, when the change in position/viewpoint changing speed is not larger than the threshold (Yes at step S1610), the information device 141 checks whether an estimated image in a position, viewpoint, and time change range of a virtual reality synthetic image is completely generated (step S1612).

When the estimated image in the position, viewpoint, and time change range of the virtual reality synthetic image is not completely generated (No at step S1612), the information device 141 moves the base point by a step of space or time or both of them according to the definition (step S1613) and returns to step S1604 to repeatedly execute the process similar to the above-described process.

On the other hand, when the estimated image in the position, viewpoint, and time change range of the virtual reality synthetic image is completely generated (Yes at step S1612), the information device 141 finishes this processing routine.

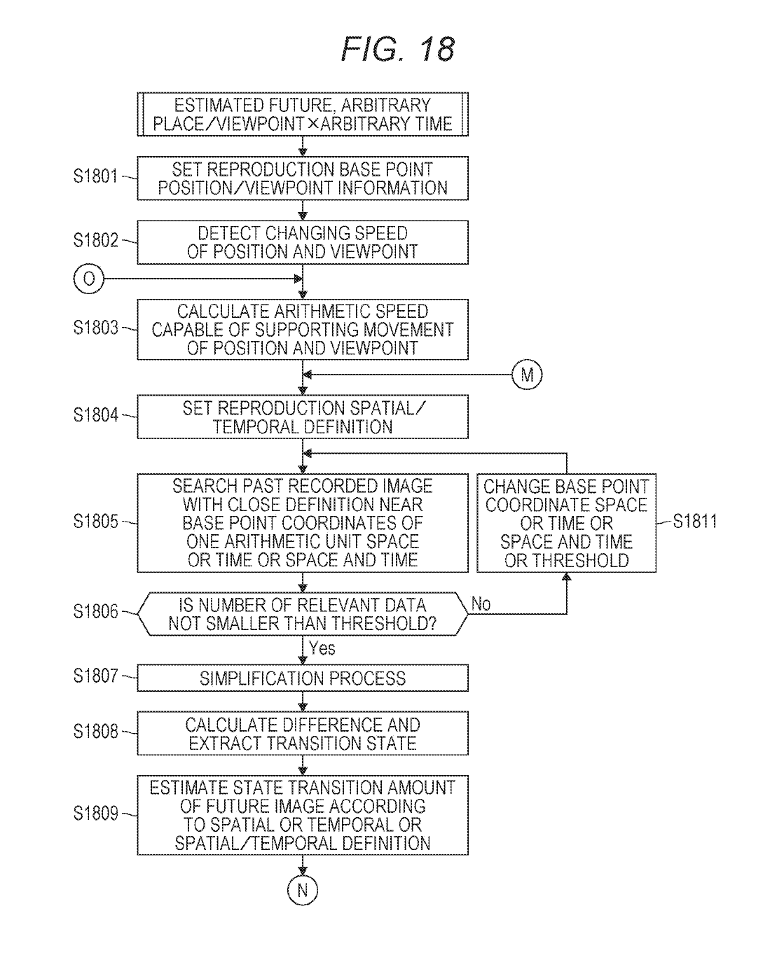

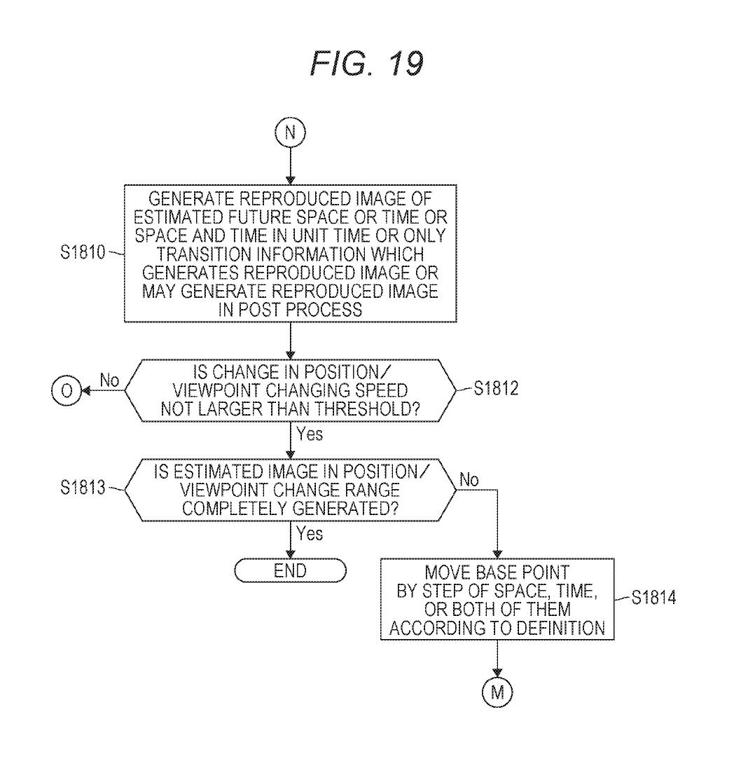

FIGS. 18 and 19 illustrate a detailed procedure of the synthesizing process of the estimated future image in arbitrary place/viewpoint and at arbitrary time executed at step S1311 of the flowchart illustrated in FIGS. 13 to 15 in a flowchart format.

The information device 141 first sets reproduction base point position and viewpoint information (step S1801).

Next, the information device 141 detects a changing speed of the position and viewpoint (step S1802).

Next, the information device 141 calculates an arithmetic speed capable of supporting movement of the position and viewpoint (step S1803).

Next, the information device 141 sets reproduction spatial/temporal definition (step S1804).

Next, the information device 141 searches a past recorded image near the base point coordinates of one arithmetic unit space or time or the space and time with close definition (step S1805).

Then, the information device 141 checks whether the number of searched relevant data is not smaller than a threshold (step S1806). Herein, when the number of relevant data is smaller than the threshold (No at step S1806), the information device 141 changes the base point coordinate space or time or space and time, or the threshold (step S1811) and returns to step S1805 to repeatedly execute the search process of the past recorded image.

When the number of relevant data is not smaller than the threshold (Yes at step S1806), the information device 141 performs a simplification process (step S1807).

Next, the information device 141 calculates difference and extracts a transition state (step S1808).

Next, the information device 141 estimates a state transition amount of the future image according to the spatial or temporal or spatial/temporal definition (step S1809).

Next, the information device 141 generates estimated future space or time or space and time reproduced image in a unit process or generates only transition information which generates the reproduced image or may generate the reproduced image by a post process (step S1810).

Next, the information device 141 checks whether change in position/viewpoint changing speed is not larger than a threshold (step S1812).

When the change in position/viewpoint changing speed is larger than the threshold (No at step S1812), the procedure returns to step S1803 and the process similar to the above-described process is repeatedly executed.

Also, when the change in position/viewpoint changing speed is not larger than the threshold (Yes at step S1812), the information device 141 further checks whether an estimated image in a position/viewpoint change range is completely generated (step S1813).

When the estimated image in the position/viewpoint change range is not completely generated (No at step S1813), the information device 141 moves the base point by a step of space or time or both of them according to the definition (step S1814) and returns to step S1804 to repeatedly execute the process similar to the above-described process.

Also, when the estimated image in the position/viewpoint change range is completely generated (Yes at step S1813), this processing routine is finished.

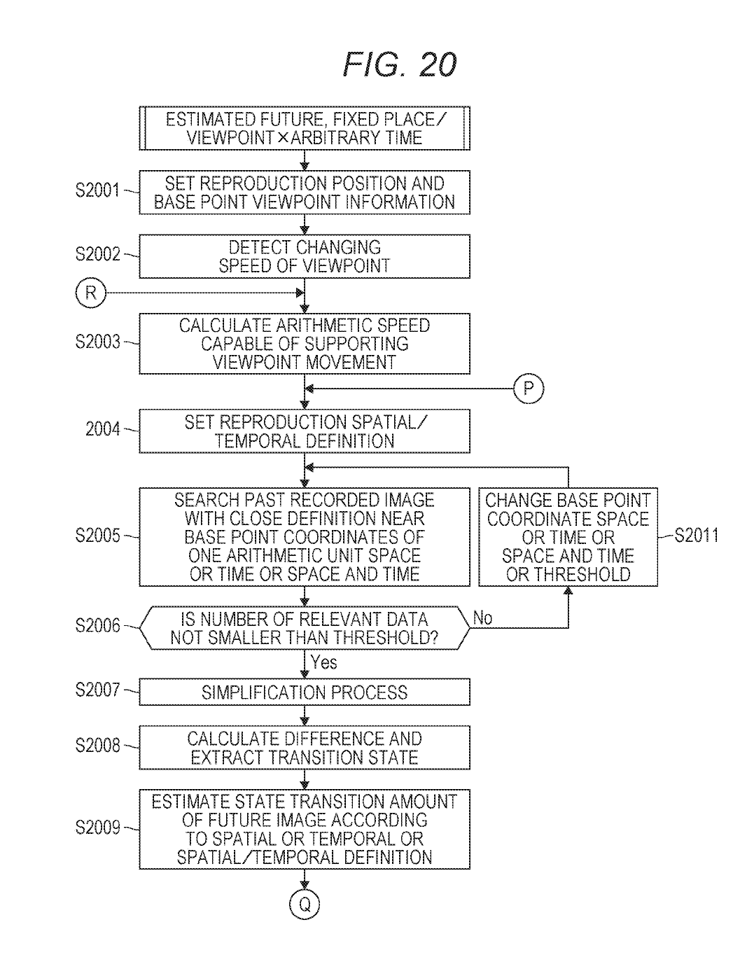

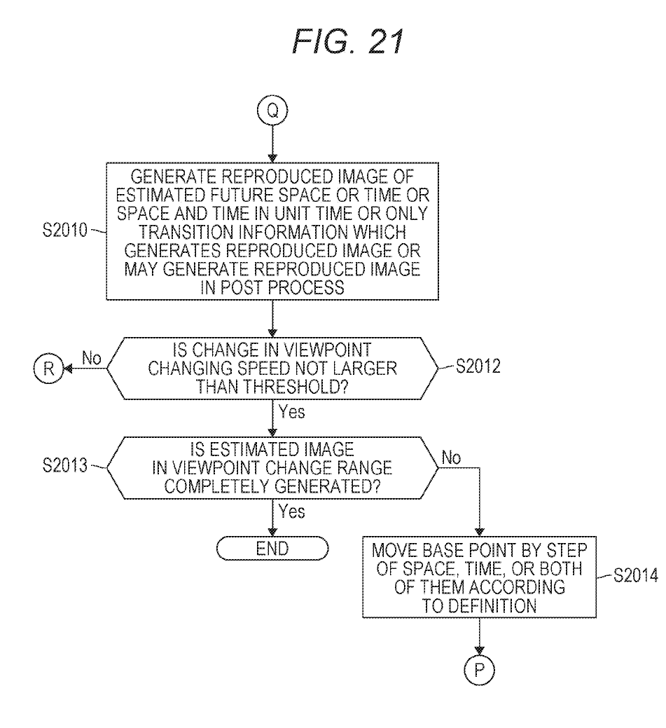

FIGS. 20 and 21 illustrate a detailed procedure of the synthesizing process of the estimated future image in the fixed place/viewpoint and at arbitrary time executed at step S1312 of the flowchart illustrated in FIGS. 13 to 15 in a flowchart format.

The information device 141 first sets reproduction position and base point viewpoint information (step S2001).

Next, the information device 141 detects a changing speed of the viewpoint (step S2002).

Next, the information device 141 calculates an arithmetic speed capable of supporting movement of the viewpoint (step S2003).

Next, the information device 141 sets reproduction spatial/temporal definition (step S2004).

Next, the information device 141 searches a past recorded image near the base point coordinates of one arithmetic unit space or time or space and time with close definition (step S2005).

Then, the information device 141 checks whether the number of searched relevant data is not smaller than a threshold (step S2006). Herein, when the number of relevant data is smaller than the threshold (No at step S2006), the information device 141 changes the base point coordinate space or time or space and time, or the threshold (step S2011) and returns to step S2005 to repeatedly execute the search process of the past recorded image.

When the number of corresponding data is not smaller than the threshold (Yes at step S2006), the information device 141 performs a simplification process (step S2007).

Next, the information device 141 calculates difference and extracts a transition state (step S2008).

Next, the information device 141 estimates a state transition amount of the future image according to the spatial or temporal or spatial/temporal definition (step S2009).

Then, the information device 141 generates an estimated future space or time or space and time reproduced image in a unit process or generates only transition information which generates the reproduced image or may generate the reproduced image by a post process (step S2010).

Next, the information device 141 checks whether change in viewpoint changing speed is not larger than a threshold (step S2012).

When the change in viewpoint changing speed is larger than the threshold (No at step S2012), the procedure returns to step S2003 and the process similar to the above-described process is repeatedly executed.

Also, when the change in position/viewpoint changing speed is not larger than the threshold (Yes at step S2012), the information device 141 further checks whether an estimated image in a position/viewpoint change range is completely generated (step S2013).

When the estimated image in the position/viewpoint change range is not completely generated (No at step S2013), the information device 141 moves the base point by a step of space or time or both of them according to the definition (step S2014) and returns to step S2004 to repeatedly execute the process similar to the above-described process.

Also, when the estimated image in the position/viewpoint change range is completely generated (Yes at step S2013), this processing routine is finished.

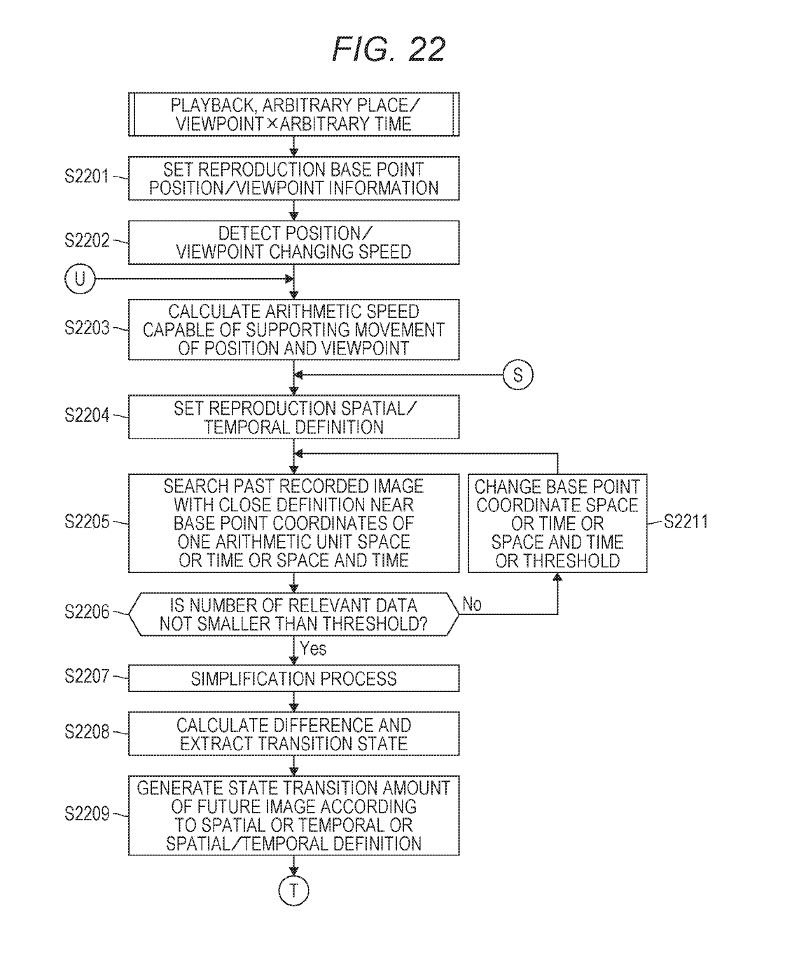

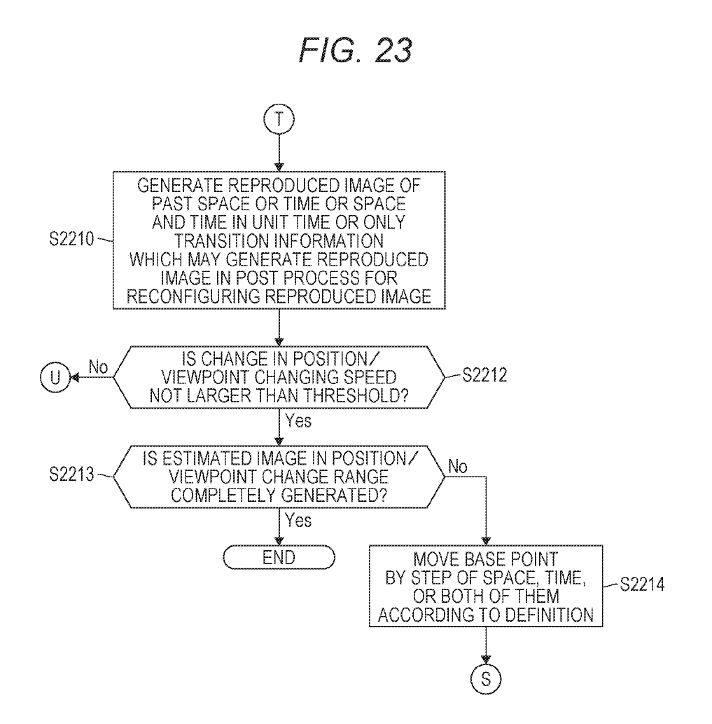

FIGS. 22 and 23 illustrate a detailed procedure of the synthesizing process of the playback image in arbitrary place/viewpoint and at arbitrary time executed at step S1313 of the flowchart illustrated in FIGS. 13 to 15 in a flowchart format.

The information device 141 first sets reproduction base point position and viewpoint information (step S2201).

Next, the information device 141 detects a changing speed of the position and viewpoint (step S2202).

Next, the information device 141 calculates an arithmetic speed capable of supporting movement of the position and viewpoint (step S2203).

Next, the information device 141 sets reproduction spatial/temporal definition (step S2204).

Next, the information device 141 searches a past recorded image near base point coordinates of one arithmetic unit space or time or space and time with close definition (step S2205).

Then, the information device 141 checks whether the number of searched relevant data is not smaller than a threshold (step S2206). Herein, when the number of relevant data is smaller than the threshold (No at step S2206), the information device 141 changes the base point coordinate space or time or space and time, or the threshold (step S2211) and returns to step S2205 to repeatedly execute the search process of the past recorded image.

When the number of relevant data is not smaller than the threshold (Yes at step S2206), the information device 141 performs a simplification process (step S2207).

Next, the information device 141 calculates difference and extracts a transition state (step S2208).

Next, the information device 141 estimates a state transition amount according to spatial or temporal or spatial/temporal definition (step S2209).

Next, the information device 141 generates an estimated future space or time or space and time reproduced image in a unit process or generates only transition information which may generate the reproduced image by a post process for reconfiguring the reproduced image (step S2210).

Next, the information device 141 checks whether change in position/viewpoint changing speed is not larger than a threshold (step S2212).

When the change in position/viewpoint changing speed is larger than the threshold (No at step S2212), the procedure returns to step S2203 and the process similar to the above-described process is repeatedly executed.

Also, when the change in position/viewpoint changing speed is not larger than the threshold (Yes at step S2212), the information device 141 further checks whether an estimated image in a position/viewpoint change range is completely generated (step S2213).

When the estimated image in the position/viewpoint change range is not completely generated (No at step S2213), the information device 141 moves the base point by a step of space or time or both of them according to the definition (step S2214) and returns to step S2204 to repeatedly execute the process similar to the above-described process.

Also, when the estimated image in the position/viewpoint change range is completely generated (Yes at step S2213), this processing routine is finished.

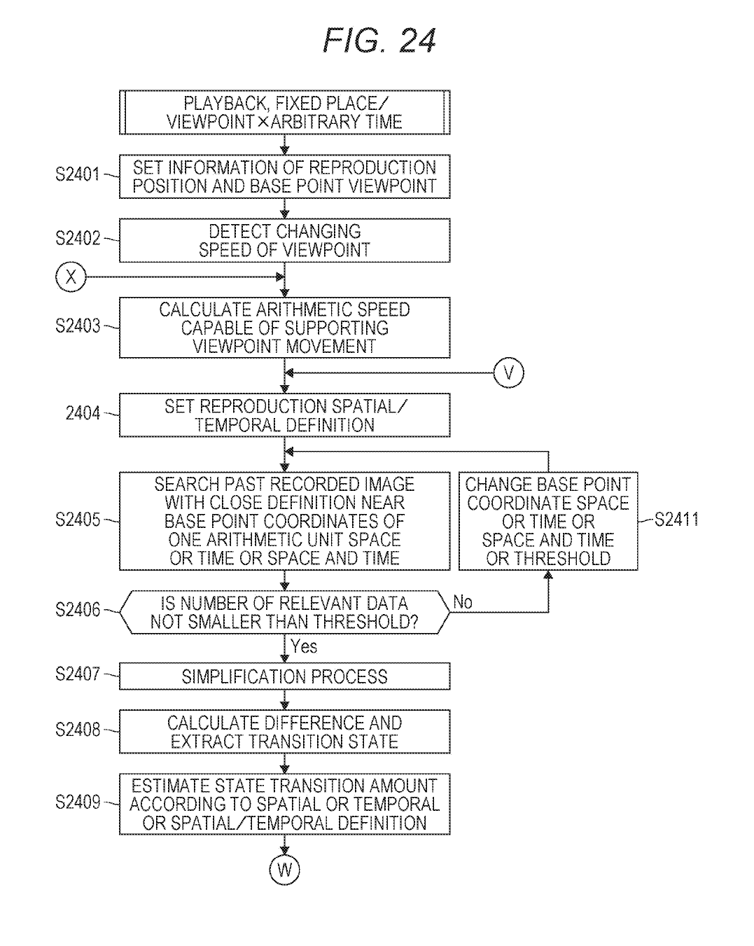

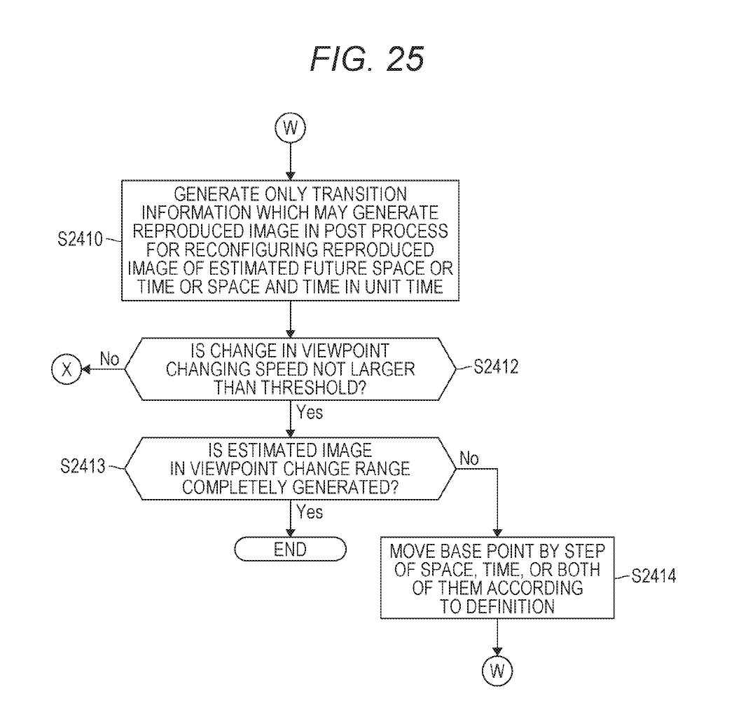

FIGS. 24 and 25 illustrate a detailed procedure of the synthesizing process of the playback image in the fixed place/viewpoint and at arbitrary time executed at step S1314 of the flow chart illustrated in FIGS. 13 to 15 in a flowchart format.

The information device 141 first sets reproduction position and base point viewpoint information (step S2401).

Next, the information device 141 detects a changing speed of the viewpoint (step S2402).

Next, the information device 141 calculates an arithmetic speed capable of supporting movement of the viewpoint (step S2403).

Next, the information device 141 sets reproduction spatial/temporal definition (step S2404).

Next, the information device 141 searches a past recorded image near the base coordinates of one arithmetic unit space or time or space and time with close definition (step S2405).

Then, the information device 141 checks whether the number of searched relevant data is not smaller than a threshold (step S2406). Herein, when the number of relevant data is smaller than the threshold (No at step S2406), the information device 141 changes the base point coordinate space or time or space and time, or the threshold (step S2411) and returns to step S2405 to repeatedly execute the search process of the past recorded image.

When the number of relevant data is not smaller than the threshold (Yes at step S2406), the information device 141 performs a simplification process (step S2407).

Next, the information device 141 calculates difference and extracts a transition state (step S2408).

Next, the information device 141 estimates a state transition amount according to the spatial or temporal or spatial/temporal definition (step S2409).

Next, the information device 141 generates an estimated future space or time or space and time reproduced image in a unit process or generates only transition information which generates may generate the reproduced image by a post process for reconfiguring the reproduced image (step S2410).

Next, the information device 141 checks whether change in viewpoint changing speed is not larger than a threshold (step S2412).

When the change in viewpoint changing speed is larger than the threshold (No at step S2412), the procedure returns to step S2403 and the process similar to the above-described process is repeatedly executed.

Also, when the change in position/viewpoint changing speed is not larger than the threshold (Yes at step S2412), the information device 141 further checks whether an estimated image in a position/viewpoint change range is completely generated (step S2413).

When the estimated image in the position/viewpoint change range is not completely generated (No at step S2413), the information device 141 moves the base point by a step of space or time or both of them according to the definition (step S2414) and returns to step S2404 to repeatedly execute the process similar to the above-described process.

Also, when the estimated image in the position/viewpoint change range is completely generated (Yes at step S2413), this processing routine is finished.

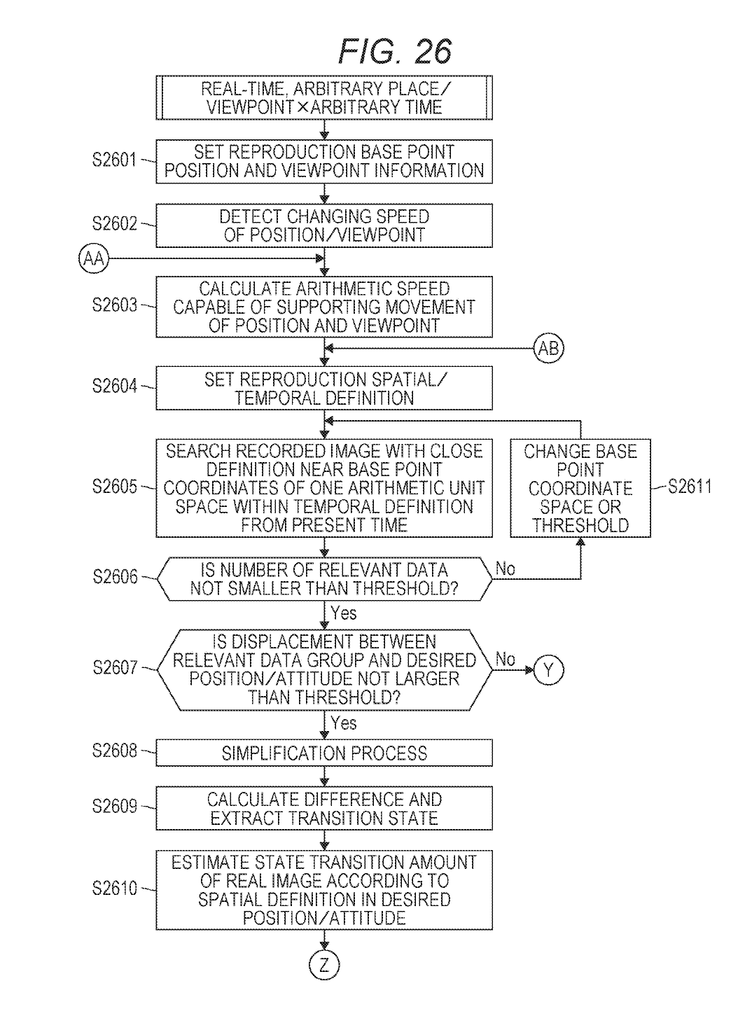

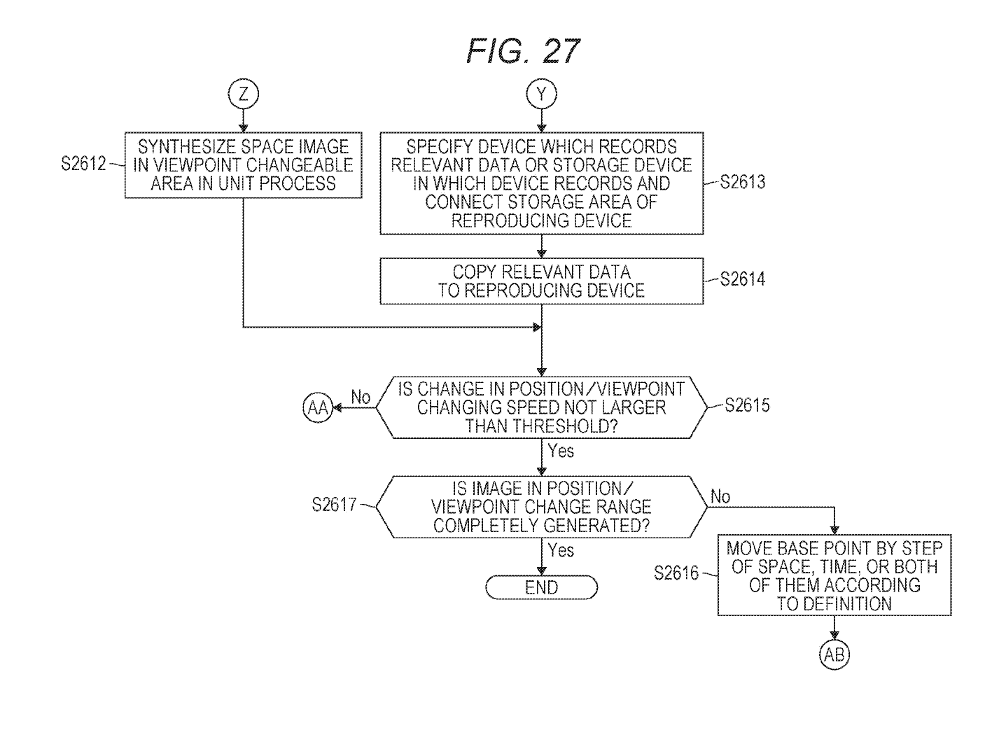

FIGS. 26 and 27 illustrate a detailed procedure of the synthesizing process of the real-time image in arbitrary place/viewpoint and at arbitrary time executed at step S1315 of the flowchart illustrated in FIGS. 13 to 15 in a flowchart format.

The information device 141 first sets reproduction base point position and viewpoint information (step S2601).

Next, the information device 141 detects a changing speed of the position and viewpoint (step S2602).

Next, the information device 141 calculates an arithmetic speed capable of supporting movement of the position and viewpoint (step S2603).

Next, the information device 141 sets reproduction spatial/temporal definition (step S2604).

Next, the information device 141 searches a recorded image with definition near the base point coordinates of one arithmetic unit space within a range of temporal definition from present time (step S2605).

Then, the information device 141 checks whether the number of searched relevant data is not smaller than a threshold (step S2606). Herein, when the number of relevant data is smaller than the threshold (No at step S2606), the information device 141 changes the base point coordinate space, or the threshold (step S2611) and returns to step S2605 to repeatedly execute the search process of the past recorded image.

Next, the information device 141 checks whether displacement between a relevant data group and desired position/attitude is not smaller than a threshold (step S2607).

When the displacement between the relevant data group and the desired position/attitude is not smaller than the threshold (Yes at step S2607), the information device 141 performs a simplification process (step S2608).

Next, the information device 141 calculates difference and extracts a transition state (step S2609).

Next, the information device 141 estimates a real image state transition amount according to the spatial or temporal or spatial/temporal definition (step S2610).

Next, the information device 141 synthesizes a space image in a viewpoint changeable area in a unit process (step S2612).

Also, when the displacement between the relevant data group and the desired position/attitude is smaller than the threshold (No at step S2607), the information device 141 specifies a device which records the relevant data or a storage device in which the device records and connects a storage area of a reproduction device (step S2613). Next, the information device 141 copies the relevant data to the reproduction device (step S2614).

Then, the information device 141 checks whether change in position/viewpoint changing speed is not larger than a threshold (step S2615).

When the change in position/viewpoint changing speed is larger than the threshold (No at step S2615), the procedure returns to step S2603 and the process similar to the above-described process is repeatedly executed.

Also, when the change in position/viewpoint changing speed is not larger than the threshold (Yes at step S2615), the information device 141 further checks whether an image in a position/viewpoint change range is completely generated (step S2617).

When the image in the position/viewpoint change range is not completely generated (No at step S2617), the information device 141 moves the base point by a step of space or time or both of them according to the definition (step S2616) and returns to step S2604 to repeatedly execute the process similar to the above-described process.

Also, when the image in the position/viewpoint change range is completely generated (Yes at step S2617), this processing routine is finished.

Operation in the information reproduction system 100 is described with reference to FIG. 1 again.

The information devices 101, 102, . . . , and 10n provided with at least one of an image recording function and an audio recording function are spread in various places of the real world to continuously record the image or audio in various points. Each of the information devices 101, 102, . . . , and 10n is the head mount display, the wristband type device, the monitoring camera, the cell phone, the tablet terminal, the digital book, the portable imaging device and the like, for example.

Each of the information devices 101, 102, . . . , and 10n stores the information which is image recorded or audio recorded in the databases 111, 112, . . . , and 11j with the position/attitude information and the time information at the time of image recording or audio recording obtained from the position/attitude detection unit 302 formed of the GPS 321, the geomagnetic sensor 322, the acceleration sensor 323, the Doppler sensor 324, the radio field intensity sensor 325 and the like added and enables sharing on the network 150.

The information devices 101, 102, . . . , and 10n may also be provided with the environment detection unit 303 formed of the temperature sensor 331, the humidity sensor 332, the infrared sensor 333, the ultraviolet sensor 334, the illuminance sensor 335, the radio field intensity sensor 336, the chemical substance (concentration, type, and state) sensor 337 and the like. The information devices 101, 102, . . . , and 10n may store the information which is image recorded or audio recorded in the databases 111, 112, . . . , and 11j with not the position/attitude information and time information but the environment information at the time of image recording or audio recording detected by the environment detection unit 303 added (or together with the position/attitude information and the time information).

Meanwhile, the process of assigning the position/attitude information, the time information, and the environment information to the information which is image recorded or audio recorded may be performed at the time of transmission from the information devices 101, 102, . . . , and 10n to the network 150 or at the time of storage in the databases 111, 112, . . . , and 11j, for example, after the transmission.

Also, although not illustrated in FIG. 2 and the like, the blur correcting function of correcting blur at the time of image recording or audio recording may further be provided. It is possible to improve the accuracy at the time of subsequent image reproduction or audio reproduction (image reproducibility, audio reproducibility, and position or attitude reproducibility) by performing the blur correction in advance on the information which is image recorded or audio recorded (as described above). Herein, the blur correcting function may include the mechanical vibration correcting mechanism around the image recording or audio recording function included in the information devices 101, 102, . . . , and 10n themselves and electrical automatic correction based on the detection result of the sensor and the detection of the periodic change in image and audio signals. The latter electrical automatic correction may also be performed by another information device and the arithmetic device 120 in addition to the information devices 101, 102, . . . , and 10n.

On the other hand, in the information devices 141, 142, . . . , and 14m on a reproduction side, that is to say, the viewing side of the image and audio may reproduce the image and audio from the viewpoint corresponding to the position and attitude of the device such that the image and audio of a state from that place may be viewed. Also, the image and audio in the past are reproduced or the image and audio in the future are generated such that the state in the place at arbitrary time may be viewed.

The information of the image and audio viewed, that is to say, reproduced by the information devices 141, 142, . . . , and 14m is basically reconfiguration of the image and audio from the viewpoint the viewing from which is wanted based on the position and attitude detected by the position/attitude detection unit 302 and present time. However, the viewpoint the viewing from which is wanted may be not current position and attitude of the information devices 141, 142, . . . , and 14m detected by the position/attitude detection unit 302 but the viewpoint arbitrarily specified by the user through the user input unit 203 and the like. It is also possible that the user specifies arbitrary time (at which time in the past, or an amount of time by which it goes back to the past or goes forward in the future from the present time) through the user input unit 203 and the like. Herein, the user is not required to set the viewpoint the viewing from which is wanted and wanted viewing time every time the image and audio are viewed, and it is possible to automatically set the viewpoint the viewing from which is wanted and reproduce the image and audio according to the return or advance time set in advance according to the line of view of the user.

Also, it is possible to reconfigure the image and audio on the basis of the environment information detected by the environment detection unit 303 such as the illuminance, temperature, acceleration, ultraviolet intensity, and chemical substance (concentration, type, state and the like) (or the system information generated by utilizing the environment information) in addition to the position/attitude information and the time information of the information devices 141, 142, . . . , and 14m. For example, the image and audio are those from the viewpoint the viewing from which is wanted based on the current position and attitude of the information devices 141, 142, . . . , and 14m, and further the image and audio matching current environment information (time period, season, weather, and whether this moves) are reconfigured.

The past image and audio information recorded by the information devices 101, 102, . . . , and 10n is reconfigured as the image and audio from the viewpoint the viewing from which is wanted by the arithmetic unit 201 of each of the information devices 101, 102, . . . , and 10n which records the image and audio itself, the arithmetic device 120 on the network 150, or the arithmetic unit 201 in each of the information devices 141, 142, . . . , and 14m on a side of reproducing the image and audio.

The arithmetic device 120 may store the information of the image and audio reconfigured from the viewpoint the viewing from which is wanted in a local storage area (not illustrated) or store in the external databases 131, 132, . . . , and 13k through the network 150.

When the image or audio is recorded by the information devices 101, 102, . . . , and 10n on the recording side, as described above, the position/attitude information and the time information at the time of image recording or audio recording obtained from the position/attitude detection unit 302 are assigned to the information of the image and audio to be recorded to be stored in the databases 111, 112, . . . , and 11j on the network 150. In contrast, each of the information devices 141, 142, . . . , and 14m on the reproduction side transmits the position/attitude information of the device to the arithmetic device 120 on the network 150 at regular intervals, or when the event such as the viewing occurs, or by predicting that the event occurs. The arithmetic device 120 reconfigures the image and audio from the viewpoint the viewing from which is wanted from the information stored in the databases 111, 112, . . . , and 11j on the basis of the received position/attitude information and supplies the same to the information devices 141, 142, . . . , and 14m.

The viewing with the information devices 141, 142, . . . , and 14m is not limited to the playback of the past image and audio; future image and audio might also be presented. That is to say, it is also possible to specify the future as the wanted viewing time. In such a case, a process of reconfiguring the future image and audio by utilizing the past image and audio stored in the databases 111, 112, . . . , and 11j is performed by the arithmetic device 120 or the information devices 141, 142, . . . , and 14m themselves. The future image and audio are reconfigured by a process of estimating the future image and audio from difference in information between certain time points, for example.

Also, the information devices 141, 142, . . . , and 14m on the reproduction side transmit the amount of time by which it goes back to the past or the amount of time by which it goes forward in the future arbitrarily set at the time of viewing to the arithmetic device 120 on the network 150 as the wanted viewing time. The information devices 141, 142, . . . , and 14m on the reproduction side or the information devices 101, 102, . . . , and 10n on the recording side are allowed to set a mark on the time point of the image and audio in advance and the marked time point may be made the reproduction point. It is also allowed to set the marks on a plurality of time points.

The mark is arbitrarily set on the image and audio. The information devices 101, 102, . . . , and 10n or the information devices 141, 142, . . . , and 14m on the reproduction side may set the mark in advance or the setting itself is automated and the time of the point matching the setting may be automatically marked. As the method of automatically generating the time at which the mark is put, the recorded image and audio may be analyzed to be listed according to objects. For example, the information which is image recorded or audio recorded is analyzed and the point at which the state transition is significantly found in the image and the components in the acoustic field is extracted as the information indicating the changing point of the image and audio. More specifically, the points of different types such as the point at which the number of component audio sources is the largest, the point at which the intensity of the audio source is high, and the point at which the range of the audio source is frequently found on the high-pitch side are extracted by the audio analysis and the time list is created. Then, the point of the type corresponding to the object is automatically marked at the time of reproduction and the like. Meanwhile, it is also possible to merely extract the specific state while narrowing the objects in advance without creating the list.

When the arithmetic device 120 receives the position/attitude information and the time information (viewpoint the viewing from which is wanted and wanted viewing time) from the information devices 141, 142, . . . , and 14m on the reproduction side, this loads the information of the image and audio around the position information of the device and around the time from the databases 111, 112, . . . , and 11j and reconfigures the image and audio to be reproduced from the wanted viewing time from the viewpoint the viewing from which is wanted. The reconfigured image and audio are reproduced (in streaming) while being loaded into the main storage unit 202 in each of the information devices 141, 142, . . . , and 14m on the reproduction side through the network 150. In this manner, the information devices 141, 142, . . . , and 14m on the reproduction side may view the image and audio from a certain time point in the place.

Meanwhile, although the example of reconfiguring the image and audio from the wanted viewing time from the viewpoint the viewing from which is wanted by the arithmetic device 120 to view is herein described, it is also possible to distribute a part of a series of processes into the arithmetic processes by the information devices 101, 102, . . . , and 10n on the recording side and the information devices 141, 142, . . . , and 14m on the reproduction side to perform.

In the information reproduction system 100 illustrated in FIG. 1, it is possible to access the image and audio recorded in the past by the user who carries the information devices 101, 102, . . . , and 10n which record the image and audio or in the place where they are installed. Therefore, it is possible to view the past state in the place in a wide area as the moving image by reconfiguring the image and audio from an arbitrary viewpoint from the image and audio from the viewpoint recorded by a plurality of information devices 101, 102, . . . , and 10n. Furthermore, it is possible to seamlessly return to a current state in the place while visually confirming the past state in the place by utilizing the high-speed reproduction technology regarding the reconfigured image and audio (for example, refer to Patent Document 2). It should be sufficiently understood that seamless connection from the past image to the current or future image is a function which the conventional recording device and reproduction device do not have.

Also, the information reproduction system 100 may also reconfigure the imaginary information from the past information actually recorded by the information devices 101, 102, . . . , and 10n and present the same by the information devices 141, 142, . . . , and 14m. It is possible to generate the imaginary scene from the real scene recorded from a certain time point in the position and attitude in which the information devices 101, 102, . . . , and 10n are installed through the arithmetic process and seamlessly combine the imaginary scene and the real scene. That is to say, although the imaginary scene is temporally or spatially different from the real scene, a process of gradually making the real scene close to the imaginary scene (or from the imaginary scene to the real scene other way round) is performed. The user who views such scene may move between the real space presented by the real scene and the virtual space presented by the imaginary scene without a sense of discomfort and may be immersed in the virtual space.

The information devices 141, 142, . . . and 14m may reconfigure a multiple-view image of different times, different positions, or different attitudes to display. It is possible to display the image at certain time from a specific viewpoint in the full screen or may combine the images from one specific viewpoint in different times, images from a plurality of viewpoints at certain time, or images from many viewpoints in different times to display. For example, it is also possible to combine the current view from the viewpoint of current position and attitude of the information devices 141, 142, . . . , and 14m with the past and future views to display and further combine the same with the view from the viewpoint of another position or attitude to display. As a method of combining a plurality of images to display, a part or all of the images may be superimposed to be displayed or all of them are displayed in parallel.

Also, the information devices 141, 142, . . . , and 14m may combine not only the image but also a plurality of audios reconfigured for each time, or each position or attitude and the environment information to output. For example, it is possible to combine the image seen from a certain viewpoint with an audio image which is not recorded from the viewpoint and it is possible to combine the image seen from a viewpoint other than a certain viewpoint with the audio image recorded from the viewpoint other way round. Similarly, it is possible to daringly combine a certain time point with the audio images recorded before and after the same to present.

A dedicated data server may be used as the databases 111, 112, . . . , and 11j which share the image and audio recorded by the information devices 101, 102, . . . , and 10n on the recording side and the position/attitude information and the environment information assigned to them and the databases 131, 132, . . . , 13k which share the image and audio reconfigured with different position/attitude and environment. Also, the moving image sharing site dedicated to posting and browsing of the moving image on the Internet is well-known in this technical field. The server of the moving image sharing site may be utilized as the databases 111, 112, . . . , and 11j and the databases 131, 132, . . . , and 13k.

When the information uploaded into the moving image sharing site is utilized by the information reproduction system 100, if the position, attitude, and time information are set in advance in the image and audio, the arithmetic device 120 utilizes the position, attitude, and time information and the image and audio to reconfigure appropriate image and audio at the time of viewing as described above, and loads the same into the information devices 141, 142, . . . , and 14m on the reproduction side through the network 150.

Also, in this embodiment, timing to set the position, attitude, and time information in the image and audio is not especially limited. Even when the position, attitude, and time information are not set in the image and audio uploaded into the moving image sharing site, the arithmetic device 120, for example, may estimate or extract appropriate position, attitude, and time information by recognition technology of the image and audio to assign to the image and audio. By this method, not only the image and audio recorded by the information devices 101, 102, . . . , and 10n on the recording side but also the image and audio already existing in the moving image sharing site may be used in the information reproduction system 100.

There also is the moving image sharing site which provides the service of writing the comment such as the note, explanation, review, criticism, and opinion in the image (for example, refer to Patent Document 3). When loading the image and audio uploaded into the moving image sharing site into the information devices 141, 142, . . . , and 14m on the reproduction side in the above-described manner, it is also possible to load the comment input by the user or by the automatic input on the moving image sharing site and other input information and reflect the comment in the image and audio to be viewed. Meanwhile, the writing to the image may be written not on the image itself but another medium such as an electronic bulletin board.

It is also possible that the arithmetic device 120, for example, collects the comment written in the moving image sharing site and other input information in the databases 131, 132, . . . , and 13k and the like to generate new control information from the information and reflect when the information devices 141, 142, . . . , and 14m reproduce the image and audio. For example, the arithmetic device 120 may realize the recommending function to extract the viewing point at which the users frequently write the comments in the moving image as the recommended reproduction viewing point to feed back to the information devices 141, 142, . . . , and 14 on the reproduction side.

Meanwhile, it is also possible to input the comment and other information when uploading the recorded image and audio from the information devices 101, 102, . . . , and 10n on the recording side into the moving image sharing site. The input information may also be a target to be processed similar to the comment input by the user or the automatically input comment on the moving image sharing site and other input information.

### FIRST EXAMPLE

When an information reproduction system 100 according to the technology disclosed in this specification is applied to viewing of a conference, a lecture, and a public lecture, it is possible to provide a smooth returning function without a sense of discomfort at the time of participation from the middle and an understanding promoting function from another viewpoint.

For example, in a place where the conference, lecture, or public lecture is taken place, a camera of a camera conference system is installed or an image is shot by a head mount display mounted on each participant. In this case, the camera installed in a hall and the head mount display mounted on the participant correspond to information devices 101, 102, . . . , and 10n on a recording side. The shot moving image is stored in databases 131, 132, . . . , 13k and the like.

The head mount display mounted on the participant is also information devices 141, 142, . . . , and 14m on a reproduction side. For example, a participant participating from the middle may view a past moving image shot in the conference, lecture, public lecture and the like by means of the head mount display mounted on the participant.

Returning Function:

When the past moving image is reproduced by the head mount display of the participant participating from the middle, it is possible to give realistic feeling as if the participant participates the conference in the place from the beginning without a sense of spatial discomfort by reconfiguring the past moving image as the image and audio from a viewpoint of the participant participating from the middle by utilizing difference between position information and attitude information of the participant participating from the middle and the position information and attitude information of the camera and the head mount display which shoot an image to output from the head mount display when reproducing the past moving image by the head mount display of the participant participating from the middle.

If the past moving image is reproduced at a standard speed, temporal difference between the past moving image viewed by the participant participating from the middle and current time does not become short, so that it is not possible to catch up with progress of the conference, lecture, and public lecture. Therefore, it is also possible to reproduce the past moving image by using high-speed reproduction technology, for example, such that the participant participating from the middle can smoothly catch up with current conference, lecture, and public lecture. The high-speed reproduction technology does not simply reproduce the moving image at a constant speed at nX (n>1) but classifies reproduced sections according to importance, compresses information while shortening a less important section than actual time, and reproduces a more important section at a reproducing speed the same as the actual time or close to the actual time (for example, refer to Patent Document 4). According to the high-speed reproduction technology, the participant participating from the middle may comprehend contents of the conference, lecture, and public lecture so far more and efficiently return to current time, so that the participant may obtain realistic feeling as if participating the conference from the beginning.

Meanwhile, a user such as the participant participating from the middle may not only reproduce the moving image from the beginning of the conference, lecture, and public lecture but also arbitrary specify time from when the reproduction starts. For example, when the user determines that it is not required to view a beginning part by looking at an agenda and the like, the user may instruct to reproduce from the middle (that is to say, a time point close to time from when the user participates).

Understanding Promoting Function:

The user sometimes wants to participate the conference, lecture, and public lecture or look at a state from a viewpoint of another or another place, for example. This is, for example, a case in which a specific person such as a speaker or a lecturer is not seen well or a white board or slide is not seen well from a place where the user currently is.

In such a case, the user requests to reproduce the moving image while specifying a desired viewpoint in place of current position information and attitude information of the user's own. For example, when the viewpoint of another participant is specified, the moving image shot from the place (moving image shot by the head mount display mounted on the other participant) may be read from the databases 111, 112, . . . , and 11j to be reproduced by the head mount display of the user who requests. In this case, a reconfiguration process of the moving image by an arithmetic device 120 and the like is not required, so that it is possible to view with a low load in further real time.

Also, when the image is not shot from the viewpoint specified by the user, the arithmetic device 120 may read the moving image shot in a place near the viewpoint from the databases 111, 112, . . . , and 11j and reconfigure the moving image from the desired viewpoint by using the difference in position information and attitude information.

Also, each user who participates the conference, lecture, public lecture and the like with delay may write a comment such as an opinion, a note, an explanation, a review, and a criticism to discussion at a certain time point in the past in the moving image and an electronic bulletin board when reproducing the shot moving image by the head mount display and the like to relive. Herein, specific means by which the user writes the comment includes character-based inputting means and means of performing a gesture input including an audio input and a sign language such as a keyboard and a pointing device similar to this and an audio input system and an input system similar to this. Furthermore, the participant who comes with delay may more efficiently relive while more deeply understanding the discussion of the conference and the contents of the lecture using the comment written in the moving image and the electronic bulletin board as a clue.

According to the returning function and the understanding promoting function of the information reproduction system 100 as described above, the user who participates the conference, lecture, and public lecture from the middle may smoothly return without a sense of discomfort. Furthermore, the user may promote the understanding (understanding of the contents and others) in the conference, lecture, and public lecture by viewing the image from the viewpoint of another and another viewpoint (different from that of the user).

### SECOND EXAMPLE

It is possible to provide a smooth returning function without a sense of discomfort when participating from the middle, an understanding promoting function from another viewpoint, and a reliving function when failing to meet an event date when an information reproduction system 100 according to the technology disclosed in this specification is applied to an event hall.

For example, an image of an event is shot by a camera of a camera conference system and a monitoring camera installed in the event hall, a camera for recording/shooting, and a heat mount display mounted on an event participant. In this case, the camera installed in a hall and the head mount display mounted on the participant correspond to information devices 101, 102, . . . , and 10n on a recording side. The shot moving image is stored in databases 131, 132, . . . , 13k and the like.

The head mount display mounted on the participant corresponds to information devices 141, 142, . . . , and 14m on a reproduction side. For example, a participant participating from the middle and a user who wants to confirm the past may view a past moving image by means of the head mount display mounted the participant/user.

When the user reproduces the past moving image with the head mount display, for example, an arithmetic device 120 reconfigures the past moving image as the image and audio from a viewpoint of the participant participating from the middle by utilizing difference between position information and attitude information of the user and the position information and attitude information of the camera and the head mount display which shoot. The user may obtain realistic feeling as if participating the event in the place from the begging without a spatial sense of discomfort by viewing the reconfigured moving image with the head mount display.

It is also possible to efficiently return to present time before the event ends by compressing the information by shortening a less important section than actual time by utilizing the above-described high-speed reproduction technology (for example, refer to Patent Document 2) when viewing the past moving image, thereby obtaining realistic feeling as if participating the event from the beginning.

The user also sometimes wants to participate the event or look at a state from a viewpoint of another or from another place because it is hard to see from the user's place. In such a case, the user requests to reproduce the moving image while specifying a desired viewpoint in place of current position information and attitude information of the user's own. For example, when the viewpoint of another participant is specified, the moving image shot from the place may be read from databases 111, 112, . . . , and 11J to be reproduced by the head mount display of the user who requests. In this case, a reconfiguration process of the moving image by an arithmetic device 120 and the like is not required, so that it is possible to view with a low load in further real time.

The user who participates the event may also upload the moving image shot from the user's viewpoint by the head mount display and the like into a moving image sharing site directly or through the databases 111, 112, . . . , and 11j. The arithmetic device 120 may reconfigure the moving image viewed by the head mount display mounted on the user who participates the event from the moving image uploaded into the moving image sharing site. A comment is sometimes written in the moving image published on the moving image sharing site. It becomes possible to provide much information to the user who participates the event with the head mount display mounted to promote realistic feeling and a sense of immersion as compared to the real by reflecting the comment written by others in the moving image reconfigured from the moving image in the moving image sharing site.

Each user who participates the event may also write a comment such as an opinion, a note, an explanation, a review, and a criticism to the event at a certain time point in the past to the moving image and an electronic bulletin board through a pointing device such as a keyboard, an audio input, a gesture input and the like when reproducing the shot moving image by the head mount display and the like to relive. Furthermore, the participant who comes with delay may more efficiently relive while more deeply understanding contents so far of the event using the comment written in the moving image and the electronic bulletin board as a clue.

According to the information reproduction system 100 as described above, the user who participates the event from the middle may smoothly return without a sense of discomfort. Furthermore, the user may promote the understanding (understanding of the contents and others) in the event by viewing the image from the viewpoint of another and another viewpoint (different from that of the user).

### THIRD EXAMPLE

When an information reproduction system 100 according to the technology disclosed in this specification is applied to a scene of an accident such as a traffic accident, a user may smoothly understand a past event without a sense of discomfort and relive by reproducing an event occurring in the past in such a place from an arbitrary viewpoint or displaying while emphasizing difference between the past and present.

For example, an image is shot by a camera of a camera conference system and a monitoring camera installed in a place such as a public space and a street corner, a head mount display mounted on a person and an animal passing by the place, and an electronic device and an imaging device similar to a monitoring system. The camera, the head mount display, and the monitoring system in this case correspond to information devices 101, 102, . . . , and 10n on a recording side. The shot moving image is stored in databases 131, 132, . . . , 13k and the like.

The head mount display mounted on a user who wants to view a past moving image at a certain point is also information devices 141, 142, . . . , and 14m on a viewing side. When the user wants to view the past moving image at a certain pint, for example, an arithmetic device 120 reconfigures the past moving image as the image and audio from a user's viewpoint by utilizing difference between position information and attitude information of the user and the position information and attitude information of the camera and the head mount display which shoot, thereby providing a scene occurred in the place in the past through the head mount display mounted on the user. The user is given an illusion of being in the place from the beginning by viewing the reconfigured moving image by the head mount display, and may confirm an event occurred in the accident scene in the past. For example, the user may confirm a situation in which the accident occurs from another viewpoint in on-the-spot investigation of the accident, thereby improving investigation accuracy.

According to the on-the-spot investigation to which the information reproduction system 100 according to the technology disclosed in this specification is applied, the investigation from the past until present from an arbitrary viewpoint of parties such as an injured party and a suspect, a peripheral monitoring camera, and a peripheral imaging device may be performed; there is an advantage over a method of investigating in which investigating time period and viewpoint are limited such as confirmation of the moving image shot by the monitoring camera and recording of a self recorder, and the on-the-spot investigation.

According to the on-the-spot investigation to which the information reproduction system 100 according to the technology disclosed in this specification is applied, change with time may be easily visually recognized by displaying while emphasizing difference between the image shot in the place in the past and a present scene, so that it becomes possible to facilitate investigation operation which is hard to confirm by normal visual recognition.

The information reproduction system 100 according to the technology disclosed in this specification is capable of not only reconfiguring the image and audio seen and heard from the position and attitude of the user who investigates the accident scene but also simultaneously reproducing audio which is normally not heard from the position. It is possible to deepen the understanding of context by confirming a situation at a certain time point while listening to the audio before and after a certain time point which is normally not heard.

### FOURTH EXAMPLE

It is possible to display a scene in a certain place and at a certain time point by applying an information reproduction system 100 according to the technology disclosed in this specification to a time travel system.

For example, an image and audio recorded by a camera conference system and a monitoring camera in a certain point, the image and audio recorded by a head mount display worn by a person and an animal passing through a certain point, the image and audio recorded by an electronic device and an imaging device similar to a monitoring system, and the image and audio recorded by the electronic device and the imaging device similar to the monitoring system mounted on an object are stored in databases 111, 112, . . . , and 11j together with position/attitude information at the time of recording.

When a user wants to look at a scene at a certain time point, the user requests an image which he/she wants to look by transmitting the position information and attitude information from a worn information device such as the head mount display, a cell phone such as a smartphone, a tablet terminal, and a digital book to an arithmetic device 120.

When the arithmetic device 120 obtains the requested image from any one of the databases 111, 112, . . . , and 11j, this reconfigures an image from a viewpoint of the user by utilizing difference in position information and attitude information to load into the information device worn by the user, thereby providing the scene at a certain time point in the place to the user. According to this, the user is given an illusion of being in a certain point in a certain time point.

The information reproduction system 100 according to this example is characterized in that an arbitrary viewpoint from which the user looks in real time is switched to the scene in a certain time point to display. By utilizing such system, the user may confirm a state in the place in an interested time period such as an atmosphere in the place in a certain time period even though the user is not in the interested time period. Also, the user may perceive with a sense of immersion in the place about history and culture how the place developed in the past. Furthermore, the user may experience a predicted future by displaying the future estimated from the past image.

The information reproduction system 100 according to this example enables pseudo time travel by virtually entering a three-dimensional global map at a certain time point. For example, application to evaluation of land and building property and to a travel guide may be considered. This may be considered as attraction. It is also possible to generate an imaginary scene through arithmetic operation from such real image at a certain time point and in certain position/attitude and use the same in a game and the like. In this case, it becomes possible to move between a real space and a virtual space without inhibiting a sense of immersion of the user by combining the imaginary scene and the real scene without a sense of discomfort, for example (by a process of gradually making temporally or spatially or temporally and spatially real scene).

### INDUSTRIAL APPLICABILITY

The present invention is heretofore described in detail with reference to the specific embodiment. However, it is obvious that one skilled in the art may modify or substitute the embodiment without departing from the scope of the present invention.

An image display device mounted on the head or face of the user (head mount display), the retina direct drawing display, an electronic contact lens, the display by electrical/physical stimulation to each sensory organ and the brain, the monitoring camera, the cell phone such as the smartphone, the tablet terminal, the digital book, the portable music player, the portable imaging device and the like may be utilized as the information devices 101, 102, . . . , and 10n on the recording side and the information devices 141, 142, . . . , and 14m on the viewing side.

Also, in addition to the dedicated server installed, the server of the moving image sharing site may be utilized as the databases 111, 112, . . . , and 11j which store the information such as the image and audio recorded by the information devices 101, 102, . . . , and 10n on the recording side and the databases 131, 132, . . . , and 13k which store the information such as the image and audio processed by the arithmetic device 120.

In short, the present invention is disclosed in a form of an example and the contents of this specification should not be interpreted in a limited manner. In order to determine the scope of the present technology, claims should be taken into consideration.

Meanwhile, the technology disclosed in this specification may also have the following configuration.

(1) An information processing device including:

an information obtaining unit which obtains information of an image or audio;

a sensor information obtaining unit which obtains position/attitude information or other sensor information when the information of the image or audio is obtained; and

a storage unit which stores the obtained information of the image or audio in a database together with the sensor information.

(2) The information processing device according to (1) described above, wherein

the storage unit stores the information of the image or audio in a dedicated database on a network or a database of a moving image sharing site.

(3) The information processing device according to (1) described above, wherein

the storage unit corrects blurring when recording the image and audio.

(4) An information processing device including:

an information obtaining unit which obtains information of an image or audio stored in a database; and

an arithmetic processing unit which reproduces information at an arbitrary time point or in an arbitrary place from information which is image recorded or audio recorded at different time or in a different place.

(5) The information processing device according to (4) described above, wherein

the database stores the information of the image or audio together with position/attitude information or other sensor information, and

the arithmetic processing unit reproduces the information of the image or audio with the position/attitude information of a viewpoint viewing from which is wanted and time.

(6) The information processing device according to (5) described above, wherein

the arithmetic processing unit performs a reproduction process of the image or audio according to temporal difference between wanted viewing time and present time.

(7) The information processing device according to (6) described above, wherein

the arithmetic processing unit generates a real-time image when the temporal difference between the wanted viewing time and the present time is smaller than a predetermined threshold.

(8) The information processing device according to (7) described above, wherein

the arithmetic processing unit generates the real-time image in arbitrary place/viewpoint when spatial difference between a generated image and a real image is not smaller than a predetermined threshold.

(9) The information processing device according (6) described above, wherein

the arithmetic processing unit generates a future image when the wanted viewing time is in the future with the temporal difference from the present time not smaller than a predetermined threshold.

(10) The information processing device according to (9) described above, wherein

the arithmetic processing unit generates the future image in arbitrary place/viewpoint and at arbitrary time when a spatial difference between a generated image and a real image is not smaller than a predetermined threshold and generates the future image in a fixed place, an arbitrary viewpoint, and at arbitrary time when the spatial difference is smaller than the predetermined threshold.

(11) The information processing device according to (6) described above, wherein

the arithmetic processing unit generates a playback image when the wanted viewing time is in the past with the temporal difference from the present time not smaller than a predetermined threshold.

(12) The information processing device according to (11) described above, wherein

the arithmetic processing unit generates the playback image in arbitrary place/viewpoint and at arbitrary time when spatial difference between a generated image and a real image is not smaller than a predetermined threshold and generates the playback image in a fixed place, an arbitrary viewpoint, and at arbitrary time when the spatial difference is smaller than the predetermined threshold.

(13) An information processing method including:

an information obtaining step of obtaining information of an image or audio;

a sensor information obtaining step of obtaining position/attitude information or other sensor information when the information of the image or audio is obtained; and

a storing step of storing the obtained information of the image or audio in a database together with the sensor information.

(14) An information processing method including:

an information obtaining step of obtaining information of an image or audio stored in a database; and

an arithmetic processing step of reproducing information at an arbitrary time point or in an arbitrary place from information which is image recorded or audio recorded at different time or in a different place.

### REFERENCE SIGNS LIST

100 Information reproduction system
101, 102 to 10n Information device (recording side)
111, 112 to 11j Database
120 Arithmetic device
131, 132 to 13k Database
141, 142 to 14m Information device (reproduction side)
150 Network
201 Arithmetic unit
202 Main storage unit
203 User input unit
204 Information input unit
205 Information output unit
206 External storage device
207 Communication unit
208 Buffer
301 Presented information input unit
302 Position/attitude detection unit
303 Environment detection unit
311 Image sensor
312 Microphone
313 Text input unit
314 Motion input unit
315 Odor input unit
316 Tactile sense input unit
317 Taste sense input unit
321 GPS sensor
322 Geomagnetic sensor
323 Acceleration sensor
324 Doppler sensor
325 Radio field intensity sensor
331 Temperature sensor
332 Humidity sensor
333 Infrared sensor
334 Ultraviolet sensor
335 Illuminance sensor
336 Radio field intensity sensor
337 Chemical substance (concentration, type, state and the like) sensor
501 Liquid crystal display
502 Organic EL display
503 Retina direct drawing display
504 Speaker
505 Tactile sense display
506 Odor display
507 Temperature display
508 Taste sense display
509 Display by electrical/physical stimulation to each sensory organ and brain

1. An information processing device comprising:
an information obtaining unit which obtains information of an image or audio;
a sensor information obtaining unit which obtains position/attitude information or other sensor information when the information of the image or audio is obtained; and
a storage unit which stores the obtained information of the image or audio in a database together with the sensor information.

2. The information processing device according to claim 1, wherein
the storage unit stores the information of the image or audio in a dedicated database on a network or a database of a moving image sharing site.

3. The information processing device according to claim 1, wherein
the storage unit corrects blurring when recording the image and audio.

4. An information processing device comprising:
an information obtaining unit which obtains information of an image or audio stored in a database; and
an arithmetic processing unit which reproduces information at an arbitrary time point or in an arbitrary place from information which is image recorded or audio recorded at different time or in a different place.

5. The information processing device according to claim 4, wherein
the database stores the information of the image or audio together with position/attitude information or other sensor information, and
the arithmetic processing unit reproduces the information of the image or audio with the position/attitude information of a viewpoint viewing from which is wanted and time.

6. The information processing device according to claim 5, wherein
the arithmetic processing unit performs a reproduction process of the image or audio according to temporal difference between wanted viewing time and present time.

7. The information processing device according to claim 6, wherein
the arithmetic processing unit generates a real-time image when the temporal difference between the wanted viewing time and the present time is smaller than a predetermined threshold.

8. The information processing device according to claim 7, wherein
the arithmetic processing unit generates the real-time image in arbitrary place/viewpoint when spatial difference between a generated image and a real image is not smaller than a predetermined threshold.

9. The information processing device according to claim 6, wherein
the arithmetic processing unit generates a future image when the wanted viewing time is in the future with the temporal difference from the present time not smaller than a predetermined threshold.

10. The information processing device according to claim 9, wherein
the arithmetic processing unit generates the future image in arbitrary place/viewpoint and at arbitrary time when a spatial difference between a generated image and a real image is not smaller than a predetermined threshold and generates the future image in a fixed place, an arbitrary viewpoint, and at arbitrary time when the spatial difference is smaller than the predetermined threshold.

11. The information processing device according to claim 6, wherein
the arithmetic processing unit generates a playback image when the wanted viewing time is in the past with the temporal difference from the present time not smaller than a predetermined threshold.

12. The information processing device according to claim 11, wherein
the arithmetic processing unit generates the playback image in arbitrary place/viewpoint and at arbitrary time when spatial difference between a generated image and a real image is not smaller than a predetermined threshold and generates the playback image in a fixed place, an arbitrary viewpoint, and at arbitrary time when the spatial difference is smaller than the predetermined threshold.

13. An information processing method comprising:
an information obtaining step of obtaining information of an image or audio;
a sensor information obtaining step of obtaining position/attitude information or other sensor information when the information of the image or audio is obtained; and
a storing step of storing the obtained information of the image or audio in a database together with the sensor information.

14. An information processing method comprising:
an information obtaining step of obtaining information of an image or audio stored in a database; and
an arithmetic processing step of reproducing information at an arbitrary time point or in an arbitrary place from information which is image recorded or audio recorded at different time or in a different place.
